(19) United States
(12) Patent Application Publication
(10) Pub. No.: US 2011/0116539 A1
(43) Pub. Date: May 19, 2011

(54) METHOD AND APPARATUS FOR VIDEO DECODING WITH REDUCED COMPLEXITY INVERSE TRANSFORM

(75) Inventors: Zhongli He, Austin, TX (US); Xianzhong Li, Shanghai (CN); Peng Zhou, Shanghai (CN)

(73) Assignee: Freescale Semiconductor, Inc., Austin, TX (US)

(21) Appl. No.: 12/617,902

(22) Filed: Nov. 13, 2009

(51) Int. Cl. H04N 7/26

(52) U.S. Cl. 375/240.2; 375/240.16; 375/240.25; 375/E07.104; 375/E07.226

(57) ABSTRACT

A method of reducing processing of fast inverse transform of an input transform block by a video decoder includes determining whether a block type is one of zero, DC, left, and top. If not, the inverse transform is performed and a residual video block is provided as residual information. When the block type is zero, inverse transform is bypassed. When the block type is DC, reduced complexity inverse transform of a DC coefficient is performing and a single residual coefficient is provided as residual information. When the block type is left, reduced complexity inverse transform of a left column of the input transform block is performed and a single column of residual coefficients is provided as residual information. When the block type is top, reduced complexity inverse transform of a top row is performed and a single row of residual coefficients is provided as residual information.

### BACKGROUND OF THE INVENTION

1. Field of the Invention

The present invention relates in general to video information processing, and more specifically to a method and apparatus for decoding video information using reduced complexity inverse transform processing.

2. DESCRIPTION OF THE RELATED ART

Video codecs are being integrated into consumer electronic devices with greater frequency. A video codec (coder-decoder) is a device capable of encoding and/or decoding video information in the form of a digital video data stream or video signal. Many optimizations are focused on improving the real-time performance of the video decoder incorporated within a video codec. A video encoder typically employs a transform process to compress information for storage and/or transmission. Many video standards, such as the MPEG-2, MPEG-4, H.263, DivX, etc., use the Discrete Cosine Transform (DCT) process for compression, in which the decoder employs Inverse DCT (IDCT) to retrieve a version of the original video signal. It has been determined that the IDCT process consumes a considerable amount of time in a multimedia device, particularly portable or hand-held devices.

### BRIEF DESCRIPTION OF THE DRAWINGS

The benefits, features, and advantages of the present invention will become better understood with regard to the following description, and accompanying drawings where:

FIG. 1 is a simplified block diagram of a video system including a reduced complexity video decoder implemented according to an exemplary embodiment;

FIG. 2 is a figurative diagram illustrating 12 different data configurations according to 12 difference “cases” including array types and block types collectively used to reduce complexity;

FIGS. 3-10 are graphic diagrams illustrating a reduced complexity one-dimension (1D) butterfly IDCT graph for transforming any row or any column having the configuration of the corresponding set of FIG. 2 according to the corresponding one of cases 2-9;

FIG. 11 is a diagram of a table summarizing the total number of computations for each of the cases 1-9 as compared to the full butterfly IDCT for each row and each column;

FIG. 12 is a block diagram illustrating reduced complexity inverse transform of a DC block having the form of the DC block of FIG. 2;

FIG. 13 is a block diagram illustrating reduced complexity inverse transform of a LEFT block having the form of the LEFT block of FIG. 2;

FIG. 14 is a block diagram illustrating reduced complexity inverse transform of a TOP block having the form of the TOP block of FIG. 2;

FIG. 15 is a more detailed block diagram of the inverse transform module of FIG. 1 according to an exemplary embodiment;

FIG. 16 is a figurative diagram illustrating reduced complexity inverse transform and reduced load and store operations for the DC block case according to an exemplary embodiment;

FIG. 17 is a figurative diagram illustrating reduced complexity inverse transform and reduced load and store operations for the LEFT block case according to an exemplary embodiment;

FIG. 18 is a figurative diagram illustrating reduced complexity inverse transform and reduced load and store operations for the TOP block case according to an exemplary embodiment;

FIG. 19 is a flowchart diagram illustrating operation of the reduced complexity video decoder of FIG. 1 according to an exemplary embodiment for each block processed;

FIG. 20 is a flowchart diagram illustrating additional detail of reduced complexity IDCT block of FIG. 19;

FIG. 21 is a flowchart diagram illustrating additional detail of the reduced complexity block of FIG. 20 according to an exemplary embodiment; and

FIG. 22 is a flowchart diagram illustrating additional detail of the load and add block of FIG. 19 according to an exemplary embodiment.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

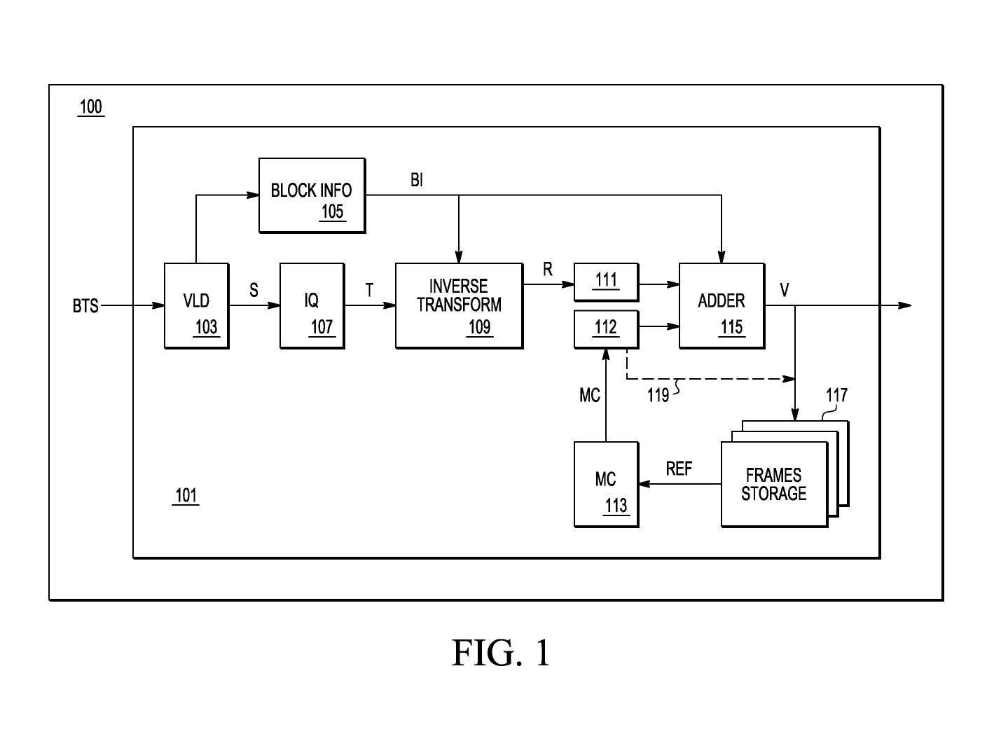

FIG. 1 is a simplified block diagram of a video system 100 including a reduced complexity video decoder 101 implemented according to an exemplary embodiment. The video system 100 is implemented according to any one of many different configurations, such as hand-held or mobile type or battery-powered devices such as, for example, a personal digital assistant (PDA), a cellular phone (or cell phone), a smart phone, a video camera, etc. The video system 100 may be incorporated within larger or more sophisticated equipment or devices, such as any type of computer system or the like incorporating video processing capabilities. The video system 100 may use wired or wireless communication receiving or transmitting encoded video information. The video decoder 101 may be stand-alone for receiving and converting an input bit stream (BTS) incorporating video information, such as one or more video streams or the like for storage or display. Alternatively, the video decoder 101 may be part of or incorporated within a video encoder. The video system 100 may include a video encoder or video decoder or both depending upon the particular implementation.

Encoded input BTS, provided by any of multiple sources, such as, for example, an external device or communication medium, or retrieved from memory, or from a video encoder (not shown), etc., is provided to an input of a variable length decoding (VLD) module 103. The VLD module 103 converts the bits of variable length code into VLD symbols S provided to an input of an inverse quantization module 107. In one embodiment, the encoded video information is a video sequence forming a series of pictures or frames. Each frame of the video information is subdivided into macroblocks (MB), in which each macroblock represents a 16×16 matrix of pixel elements (pixels) or the like. In one embodiment, each MB includes a 16×16 block of luminance or luma (Y) components (which includes four 8×8 luma blocks), an 8×8 block of blue difference chroma (Cb) components, and an 8×8 block of red difference chroma (Cr) components, for a total of six 8×8 blocks of components.

A block information module 105, coupled to the VLD module 103, receives VLD information from the VLD module 103 and determines block information BI which is used to provide information used to reduce complexity of the decoding process as further described below. In one embodiment, the block information BI is in the form of two variables for each block, including a first count variable BLKRCNT indicating how many non-zero coefficients exist in each row of a given block, and a second index variable BLKRIDX indicating the index or position of the rightmost non-zero coefficient in each row of the block. In one embodiment for each 8×8 block, each variable is a 32-bit variable of the form 0xdddddddd in which each digit “d” provides a value for a corresponding row of the block. As an example, BLKRCNT=0x00001022 indicates that the corresponding block has 2 non-zero variables in the top row (indicated by the right-most digit), 2 non-zero variables in the second row from the top, 0 non-zero variables in the third row, and 1 non-zero variable in the fourth row, in which the remaining coefficients are zeroes. BLKRIDX=0x00000012 indicates that the right-most non-zero coefficient in the top row is in the third column from the left (index of 2 ranging from an index of 0 for the left-most column to 7 for the right-most column), the right-most non-zero coefficient in the second row from the top is in the second column from the left, and otherwise any non-zero coefficients, if any, are in the left-most column of the block. Taken together, or BLKRCNT=0x00001022 and BLKRIDX=0x00000012 for the same 8×8 block, indicates that the block has a top row with two non-zero coefficients with the right-most non-zero coefficient in the third position and the remaining coefficients to the right being 0, a second row with two non-zero coefficients in the first two positions with the remaining coefficients being zero, a third row without any non-zero values, a four row having only one non-zero coefficient in the first position, and four lower rows without any non-zero variables.

The inverse quantization module 107 module performs inverse quantization and provides corresponding transform blocks T to an input of a reduced complexity inverse transform module 109. In the illustrated embodiment, each transform block T is a block of DCT coefficients. In one embodiment, the inverse transform module 109 performs reduced complexity two-dimensional (2D) fast inverse discrete cosine transform (IDCT) on each block to provide corresponding residual information in the form of residual values R to a memory 111. In a conventional configuration, residual information is in the form of entire residual blocks for each received input block in which multiple residual blocks form a residual image. As described herein for reduced complexity, the residual information is reduced, and may include as little as a single residual variable (or pixel) up to an entire block of residual variables for each video block. The size and format of the residual value R for each block (single value, single row of values, single column of values, entire block of values) depends upon the level of complexity reduction, which further depends on the block information BI received from the block information module 105 as further described below.

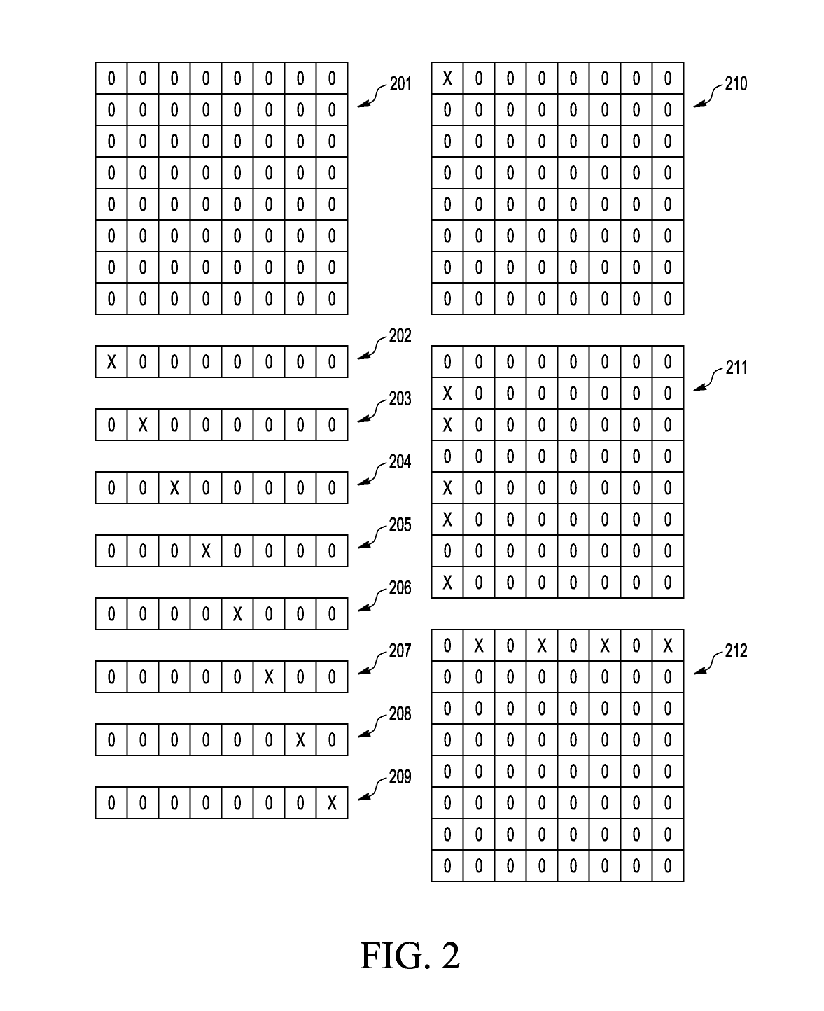

A motion compensation (MC) module 113 performs motion compensation and provides motion compensation blocks MC for temporary storage in a buffer memory 112. The memories 111 and 112 may be separate portions of the same memory device or system although shown as separate memories for clarity of illustration. Multiple motion compensation blocks MC for a motion compensated image to be combined with corresponding portions of the residual image to form video frames of the video output. Corresponding portions of the residual value R and the motion compensation blocks MC are loaded into respective inputs of an adder module 115, which adds the information together and outputs corresponding video blocks V as the video output. The video blocks V are further stored in a frame storage memory 117 and provided to the motion compensation module 113 as reference information REF as understood by those skilled in the art. As further described herein, the inverse transform module 109 significantly reduces the amount of computations as compared to conventional configurations to substantially reduce overall computation complexity of the video system 100. Furthermore, the inverse transform module 109 significantly reduces the amount of residual data without losing information, thereby significantly reducing data storage operations. The reduction of data stored in the memory 111 further reduces the amount of data loaded into the adder 115 thus further reducing computation complexity. In one embodiment, when a transform block T is a ZERO block (e.g., 201 shown in FIG. 2) having only zero values (no non-zero values), the inverse transform module 109 does not perform inverse transform for the ZERO block and does not store any data into the memory 111. The adder 115 does not load a ZERO block but instead uses the corresponding MC block from the memory 112 as a video block V stored into the frame storage 117 unmodified as indicated by dashed line 119.

FIG. 2 is a figurative diagram illustrating 12 different data configurations according to 12 difference “cases” including array types and block types collectively used to reduce complexity. The ZERO block 201, illustrating case 1, is an 8×8 block in which each coefficient is zero (‘0″) such that there are not any non-zero coefficients. A ZERO block 201 is indicated when the block information is BLKRCNT=0x00000000 (or BLKRCNT=0). The next 8 cases 2-9 illustrate array configurations for any row or any column of a block. A first set 202, for case 2, is an array of 8 coefficients representing any row or any column of a block in which the first coefficient is the only non-zero coefficient in the set, in which a non-zero value is indicated by “X”. Similarly, a second set 203, for case 3, is an array of 8 coefficients representing any row or any column of a block in which the second coefficient is the only non-zero coefficient in the set. Likewise, a third set 204, for case 4, is an array of 8 coefficients representing any row or any column of a block in which the third coefficient is the only non-zero coefficient in the set, a fourth set 205, for case 5, is an array of 8 coefficients representing any row or any column of a block in which the fourth coefficient is the only non-zero coefficient in the set, a fifth set 206, for case 6, is an array of 8 coefficients representing any row or any column of a block in which the fifth coefficient is the only non-zero coefficient in the set, a sixth set 207, for case 7, is an array of 8 coefficients representing any row or any column of a block in which the sixth coefficient is the only non-zero coefficient in the set, a seventh set 208, for case 8, is an array of 8 coefficients representing any row or any column of a block in which the seventh coefficient is the only non-zero coefficient in the set, and finally, an eighth set 209, for case 9, is an array of 8 coefficients representing any row or any column of a block in which the eighth coefficient is the only non-zero coefficient in the set.

The final 3 cases 10-12 illustrate three different block types. Case 10 is illustrated by a direct current (DC) block 210, which is an 8×8 block having a single non-zero coefficient in the top-left corner or position. The terms “DC” and “direct current” are used interchangeably and are intended to have the same meaning as used herein. The remaining coefficients in the DC block 210 are zeroes. A DC block 210 is indicated when the block information is BLKRCNT=0x00000001 and BLKRIDX=0x00000000. Case 11 is illustrated by a LEFT block 211, which is an 8×8 block in which there are one or more non-zero coefficients in the left-most column (other than a single non-zero coefficient in the top-left position for the DC block 210) and in which the remaining coefficients in the block are zero. A LEFT block 211 is indicated when the block information is BLKRCNT>0 and BLKRIDX=0x00000000. Case 12 is illustrated by a TOP block 212, which is an 8×8 block in which there are one or more non-zero coefficients in the top-most row (other than a single non-zero coefficient in the top-left position for the DC block 210) and in which the remaining rows are filled with zeroes. A TOP block 212 is indicated when the block information is such that 0x00000000<BLKRCNT<0x0000008 (meaning the right-most index is non-zero and the remaining index coefficients are zero) and BLKRIDX>0x00000000 (to distinguish from the DC block 210). The different types of blocks are represented by a parameter BLKTYPE based on the BLKRCNT and BLKRIDX variables, in which the BLKTYPE parameter is one of a set of coefficients {ZERO, DC, LEFT, TOP, OTHER}, in which BLKTYPE=ZERO for any block having the format of a ZERO block 201, BLKTYPE=DC for any block having the format of a DC block 210, BLKTYPE=LEFT for any block having the format of a LEFT block 211, BLKTYPE=TOP for any block having the format of a TOP block 212, and otherwise BLKTYPE=OTHER for any other block not meeting the conditions for block types ZERO, DC, LEFT, or TOP.

In a conventional configuration, a full 2D butterfly IDCT is performed in two stages for each input transform block, including a full 1D butterfly IDCT for each row of the block providing an intermediate block, followed by a full 1D butterfly IDCT for each column of the intermediate block for providing the residual block. The full IDCT process occupies considerable decoding time given that each macroblock of a frame is represented by 6 8×8 blocks. In one embodiment, the full 1D butterfly IDCT for each row or for each column includes 18 multiply operations and 26 add operations for a total of 44 mathematical computations. The full 1D butterfly IDCT for each of 8 rows thus includes 352 computations followed by another 352 computations for the full column transform for a total of 704 computations. It has been determined, however, that most coefficients are 0 so that most calculations for zero coefficients are redundant and therefore unnecessary. In many conventional configurations, however, most or all of the computations are performed even for zero coefficients.

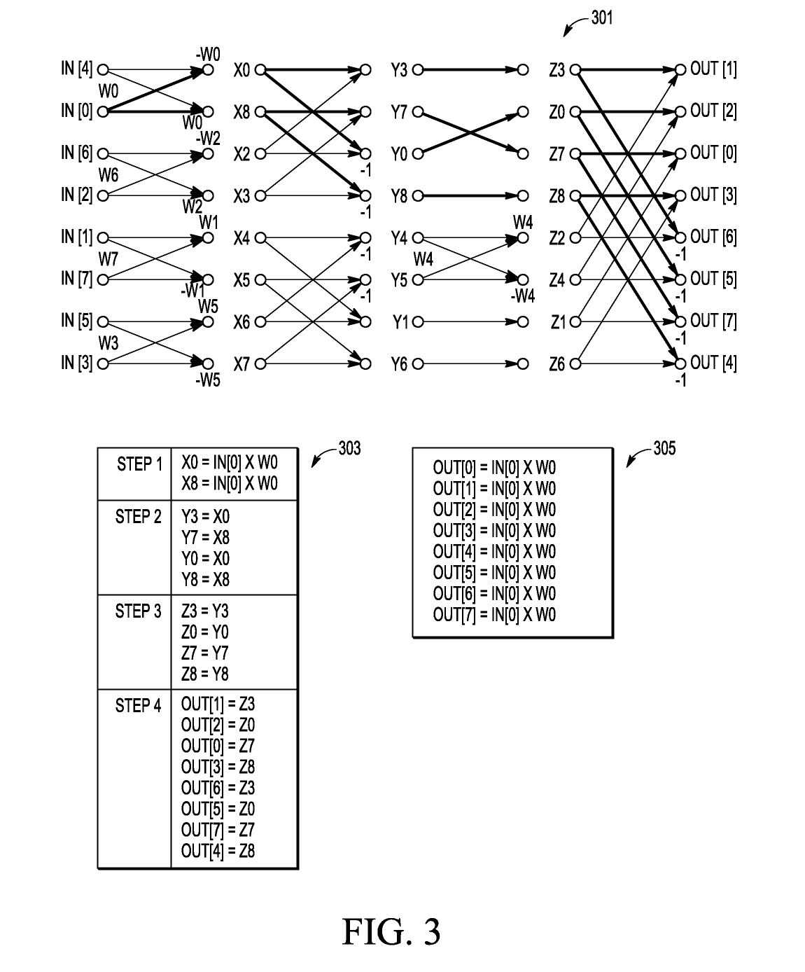

FIG. 3 is graphic diagram illustrating a reduced complexity one-dimension (1D) butterfly IDCT graph 301 for transforming any row or any column having the configuration of the first set 202 according to case 2. As previously described, case 2 applies when the first coefficient of a row or column array is the only non-zero coefficient. Each of a set or array of input coefficients IN[0:7] is provided on the left of graph 301 to a corresponding one of an array of input nodes, and a set or array of output coefficients OUT[0:7] is provided on a corresponding array of output nodes on the right of the graph 301 as illustrated. For case 2, IN[0] is the only non-zero coefficient, so that the inputs IN[1:7] are zero. Intermediate nodes indicated with intermediate coefficients X0 and X2-X8, Y0-Y1 and Y3-Y8, and Z0 Z4 and Z6-Z8 are shown between the input and output nodes, coefficient multipliers W0-W7 are shown near certain nodes, and arrows are drawn between nodes illustrate intermediate computations performed for the inverse transform as understood by those skilled in the art. The full set of arrows, including regular (non-bold) arrows and bold arrows, collectively illustrate the computations for the full 1D butterfly IDCT. The bold arrows illustrate the computation paths used for the reduced complexity 1D butterfly operation for the first set 202, in which the first input coefficient IN[0] is non-zero and the remaining input coefficients IN[1:7] are zero. It is readily apparent from graph 301 that at least more than half the computation paths are eliminated.

Table 303 illustrates the computations performed for each of 4 steps for the reduced complexity 1D butterfly IDCT for case 2, including a first step for determining the X coefficients, a second step for determining the Y coefficients, a third step for determining the Z coefficients, and a final fourth step for determining the output coefficients OUT[0:7]. In the full transform, each of the X, Y and Z coefficients are determined based on corresponding calculations. As shown in table 303, however, only two X coefficients are determined in the first step, and both are determined by a single computation IN[0] multiplied by a coefficient WO, or IN[0]*W0 (in which an asterisk “*” denotes multiplication, which may also be indicated using parentheses, such as IN[0](W0)). Also, only four Y coefficients are determined, and the Y coefficients are directly determined from the two X coefficients so that no further computations are necessary. Furthermore, only four Z coefficients are determined, and the Z coefficients are directly determined from the four Y coefficients without further computation. Finally, the output coefficients OUT[0:7] are each determined directly from the four Z coefficients without further computation. In this manner, the output coefficients OUT[0:7] are all determined using only one calculation. Table 305 shows a summary of computations for each output coefficient, in which each of the output coefficients are the same coefficient, or OUT[i] =IN[0]*W0 in which “i” is an index value ranging from 0 to 7, or i=0 to 7. In summary, for the reduced complexity 1D butterfly IDCT according to graph 301 and tables 303 and 305, only one computation is performed rather than 44 used for the full transform. This provides a very considerable reduction in computation complexity.

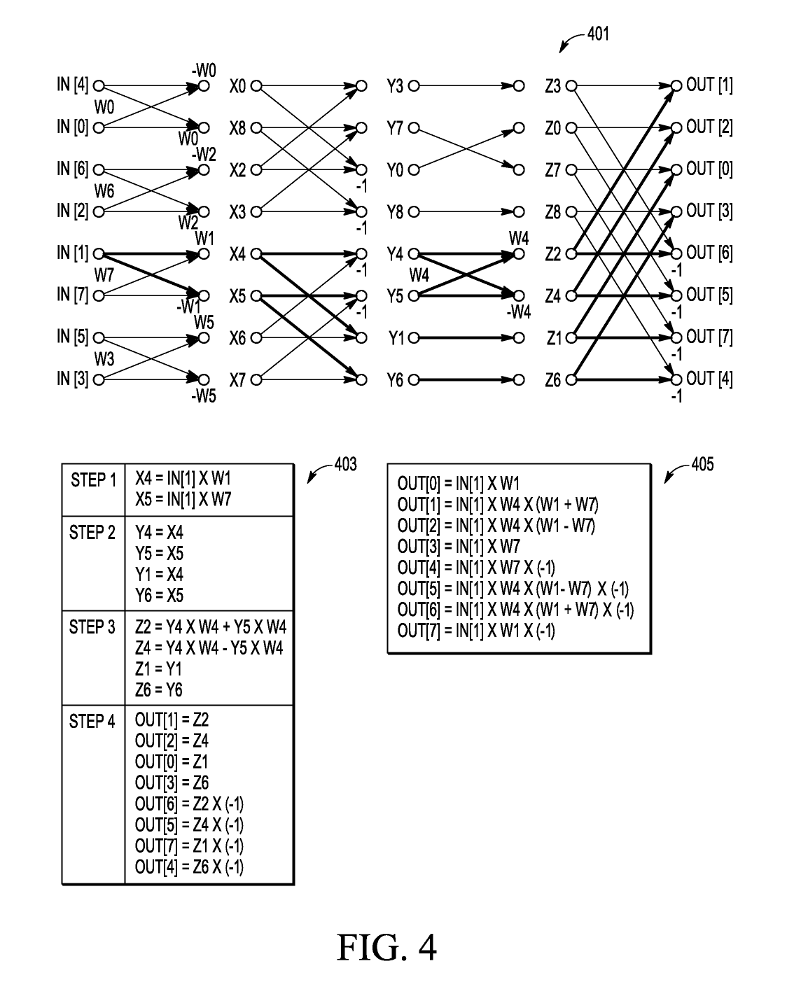

FIG. 4 is graphic diagram illustrating a reduced complexity 1D butterfly IDCT graph 401 for transforming any row or any column having the configuration of the second set 203 according to case 3. Graph 401 is similar to graph 301 including the same input, intermediate and output nodes and coefficient multipliers. As previously described, case 3 applies when the second coefficient of the row or column array is the only non-zero coefficient. The second coefficient is input IN[1] which is the only non-zero input coefficient, so that the input coefficients IN[0] and IN[2:7] are zero. Again, the full set of arrows are shown collectively illustrating the computations for the full 1D butterfly IDCT, and the bold arrows illustrate the computation paths used for the reduced complexity 1D butterfly IDCT when the second input coefficient IN[1] is the only non-zero coefficient. Table 403 illustrates the computations performed for each of 4 steps for the reduced complexity 1D butterfly IDCT for case 3. Certain computations indicate multiplication by (−1), which is a direct determination such that the coefficient is simply negated and additional computation is not necessary. Table 405 shows a summary of computations for each output coefficient. In this case the output coefficients are not equal to each other, but are nonetheless considerably reduced as compared to the full transform. In this case a total of only 10 computations are performed.

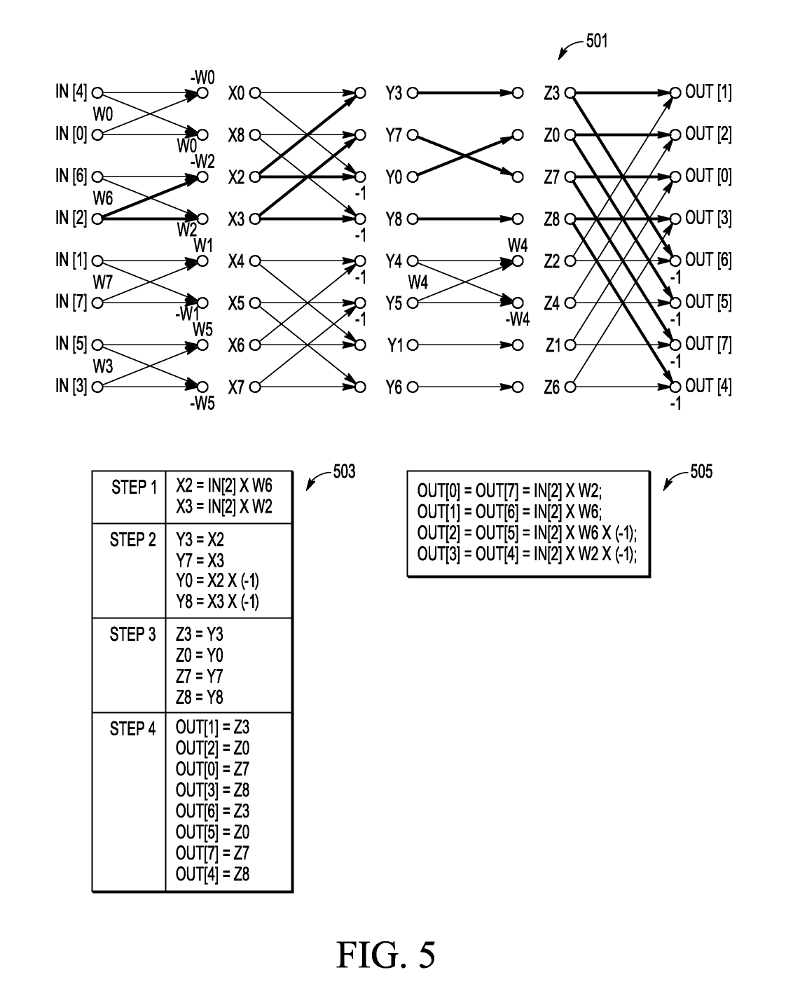

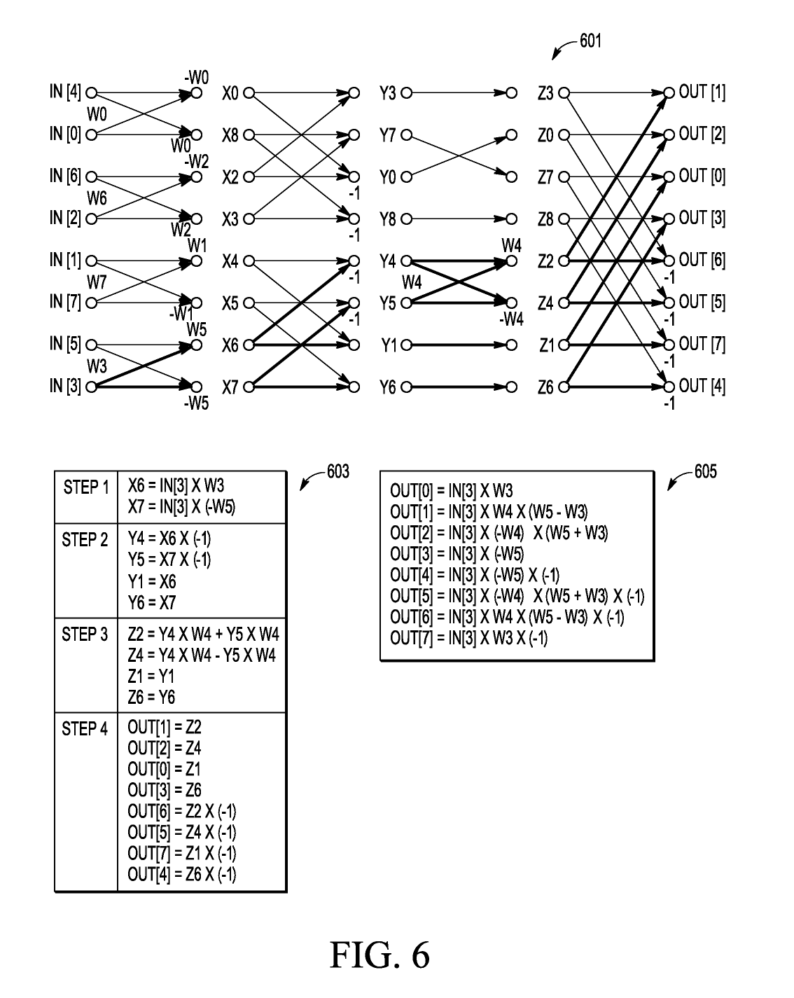

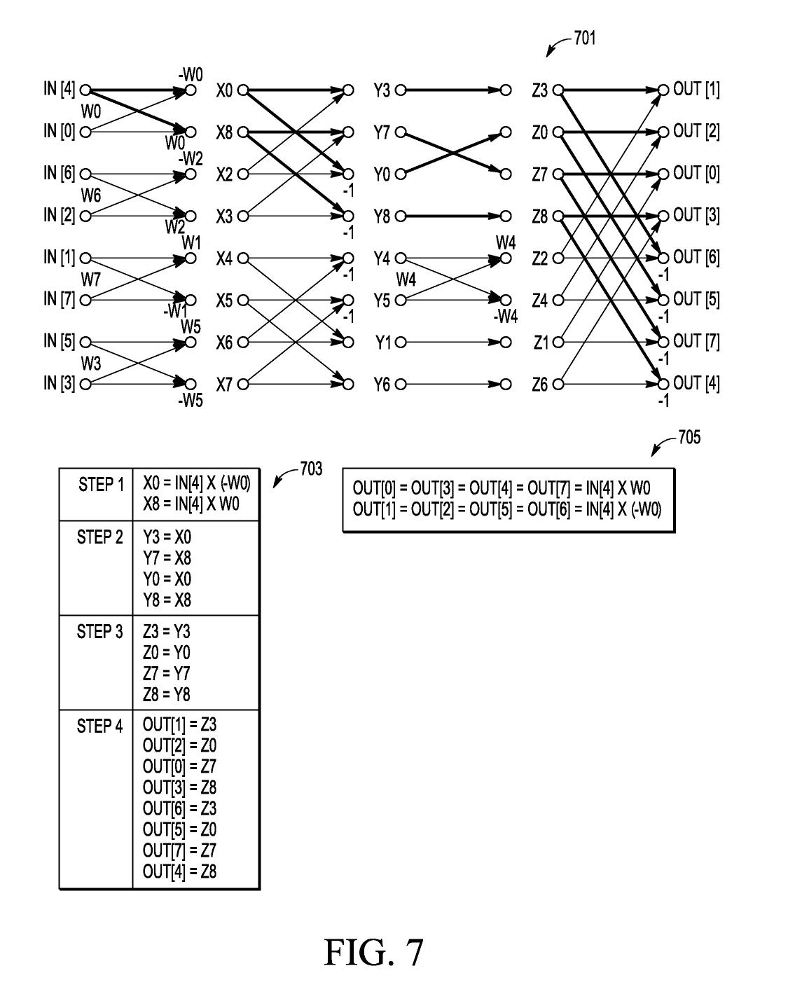

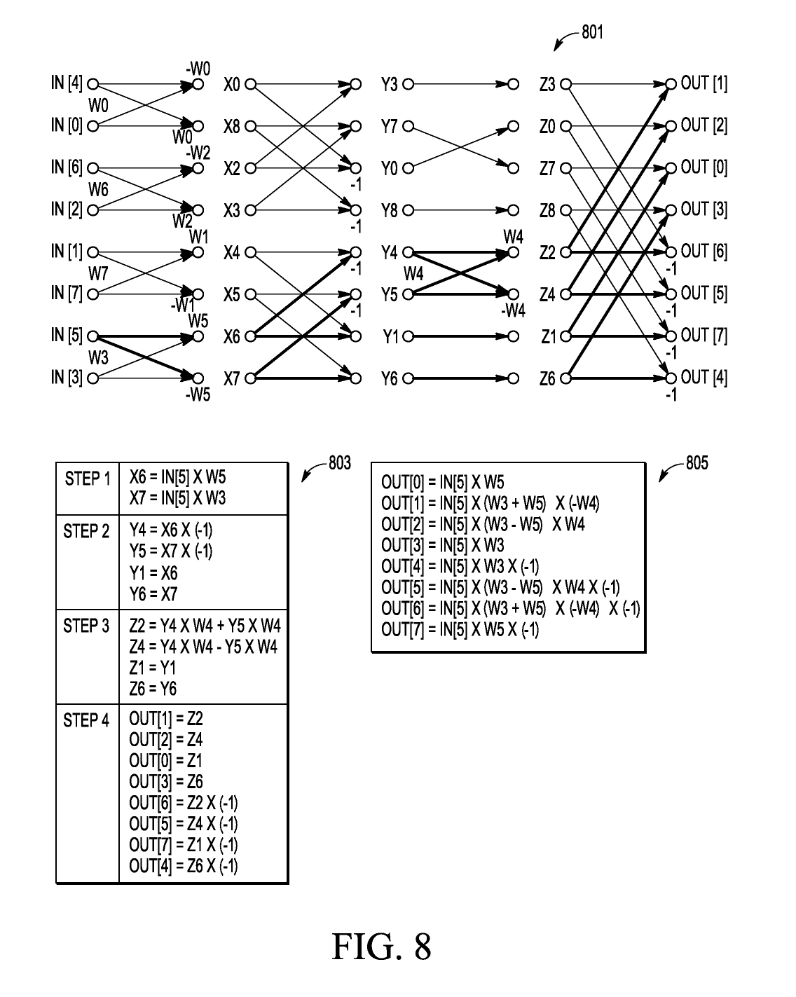

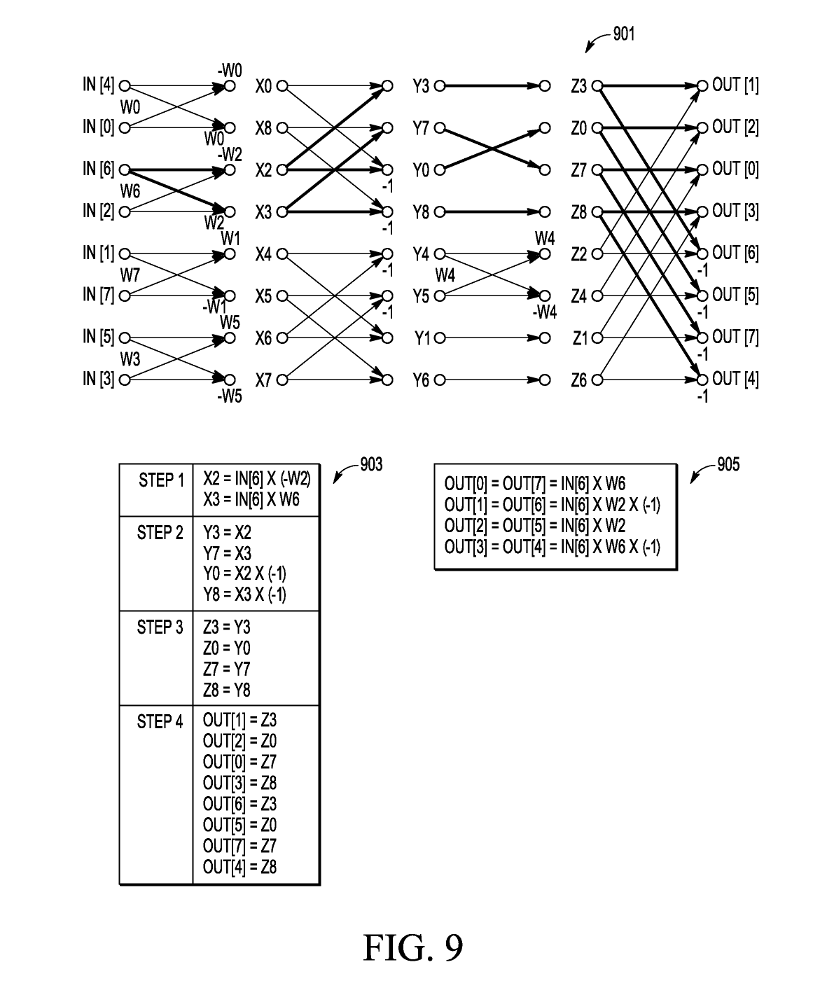

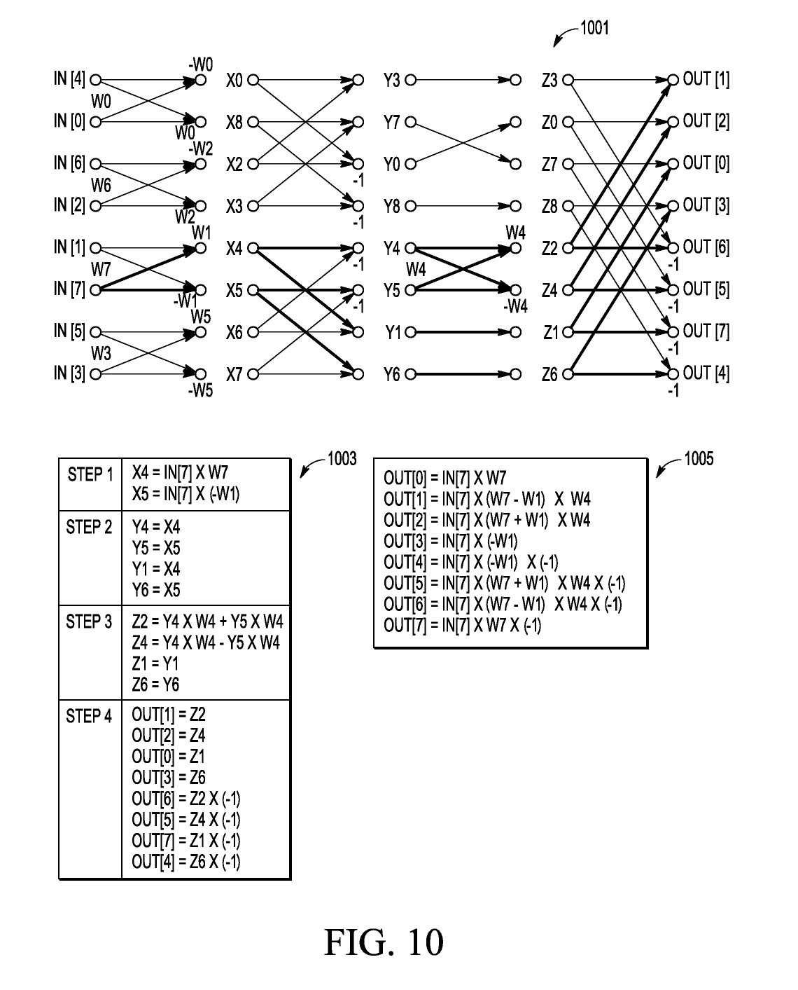

In a similar manner, FIGS. 5-10 are graphic diagrams illustrating reduced complexity 1D butterfly IDCT graphs 501, 601, 701, 801, 901 and 1001, respectively, for transforming any row or any column having the configuration of sets 204-209, respectively, according to cases 4-9, respectively. Each of the graphs 501-1001 includes the same input, intermediate and output nodes, coefficient multipliers, and full set of arrows. The bold arrows, however, are shown specific to each of the respective cases. Corresponding tables 503, 603, 703, 803, 903 and 1003 each illustrate the computations performed for each of 4 steps for the respective cases 4-9, and tables 505, 605, 705, 805, 905 and 1005 each show a summary of computations for each output coefficient for the respective cases 4-9.

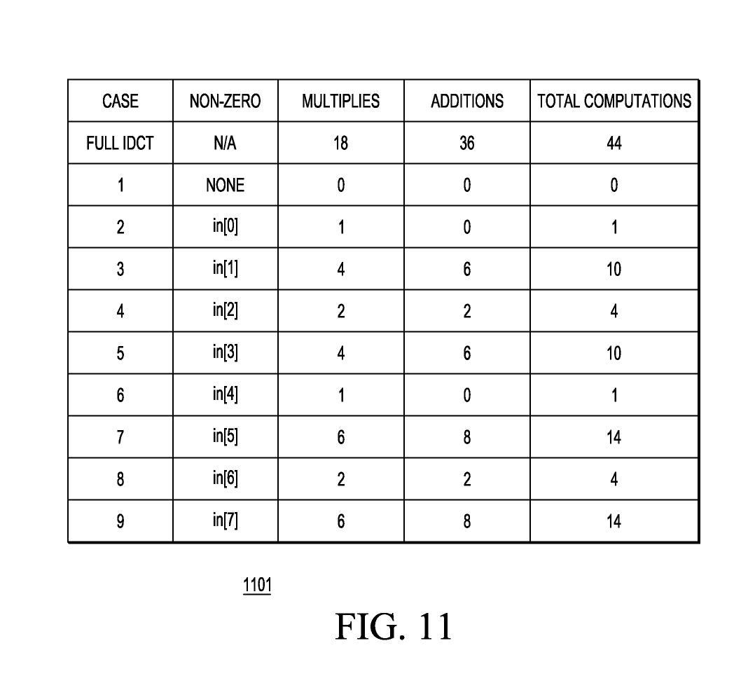

FIG. 11 is a diagram of a table 1101 summarizing the total number of computations for each of the cases 1-9 as compared to the full butterfly IDCT for each row and each column. As previously stated, in one embodiment the full IDCT transform has a total of 44 computations. Case 1 is shown illustrating that there are no computations performed for the entire block for case 1 in which there are no non-zero coefficients. Case 1, where the first input coefficient IN[0] is the only non-zero coefficient for the row or column, has only 1 multiply computation and 0 additions for the entire inverse transform. The remaining cases are summarized, in which cases 7 (IN[5] non-zero) and case 9 (IN[7] non-zero) each have 14 computations which is the largest number of computations for any of the reduced complexity inverse transforms. The average number of computations for the eight cases 2-9 is about 7.25 which less than 8 as compared to 44 for the full transform.

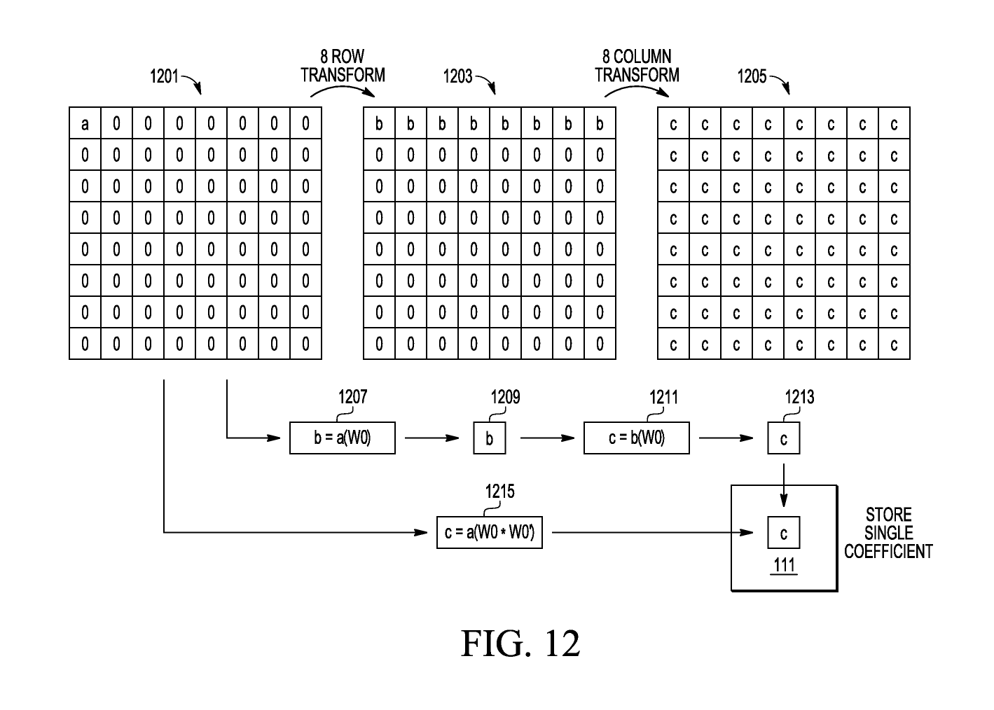

FIG. 12 is a block diagram illustrating reduced complexity inverse transform of a DC block 1201 having the form of the DC block 210. The DC block 1201 has only one non-zero coefficient “a” in the top-left corner in which the remaining block coefficients are zeroes. An intermediate block 1203 is shown as the result of a full 1D butterfly IDCT for each row of the DC block 1201, in which each position in the top row is a coefficient “b” and the remaining coefficients are zeroes. A residual block 1205 is shown as the result of a full 1D butterfly IDCT for each column of the intermediate block 1203, in which every position in the block is a coefficient “c”. In this case, the top row of the DC block 1201 has the form of the first set 202 for case 2 in which the single non-zero input coefficient “a” in the first position of the row results in the same output coefficient “b” for all positions in the top row. A full 1D inverse transform for a row of zeroes without any non-zero coefficients results in a row of zeroes, so that the remaining rows of the intermediate block 1203 are rows of zeroes. Furthermore, each column of the intermediate block 1203 also has the form of the first set 202 for case 2, in which the single non-zero input coefficient “b” in the first position of each column results in the same output coefficient “c” for all positions in the same column of the residual block 1205. In a conventional configuration, a full 1D butterfly IDCT is performed for each row of the DC block 1201 resulting in the intermediate block 1203, followed by a full 1D butterfly IDCT performed for each column of the intermediate block 1203 resulting in the residual block 1205, which was then stored in memory in its entirety for the subsequent addition.

The reduced complexity inverse transform module 109, however, simplifies the entire process for transforming the DC block 1201 to provide the same results with significantly less computations. In one embodiment as shown at 1207, the inverse transform module 109 receives the block information BI indicating a DC block, and the inverse transform module 109 performs a single computation b=a*W0, or a(W0), to provide a single intermediate coefficient “b” shown at 1209 representing the entire intermediate block 1203. The inverse transform module 109 then performs a second computation c=b(W0) shown at 1211 resulting in a single residual coefficient “c” shown at 1213. The single coefficient “c” is the residual value R which is stored in the memory 111 rather than the entire residual block 1205. Thus, the single coefficient “c” represents the residual block 1205. In this manner, the number of computations is substantially reduced, and the store operation is reduced from storing an entire 8×8 block of coefficients to storing a single coefficient “c” representing the residual block 1205. In an alternative embodiment shown at 1215, the coefficient “c” is determined in a single computation c=a(W0*W0′) where WO is the coefficient for 1D row transform, and W0′, a scaled version of W0, is the 1D column transform. The resulting single residual coefficient “c” is stored in the memory 111 in the same manner. In this case, the value W0*W0′ is pre-stored or predetermined to enable a single computation for transforming a DC block into a single residual coefficient representing the entire residual block. In the first embodiment shown at 1207-1213, only two computations are performed, and in the second embodiment shown at 1215, only one computation is performed, thereby substantially reducing the number of computations for transforming the DC block 1201. Furthermore, a single residual coefficient “c” is determined to represent the entire residual block 1205, and only the single coefficient is stored into the memory 111 substantially reducing memory store operations.

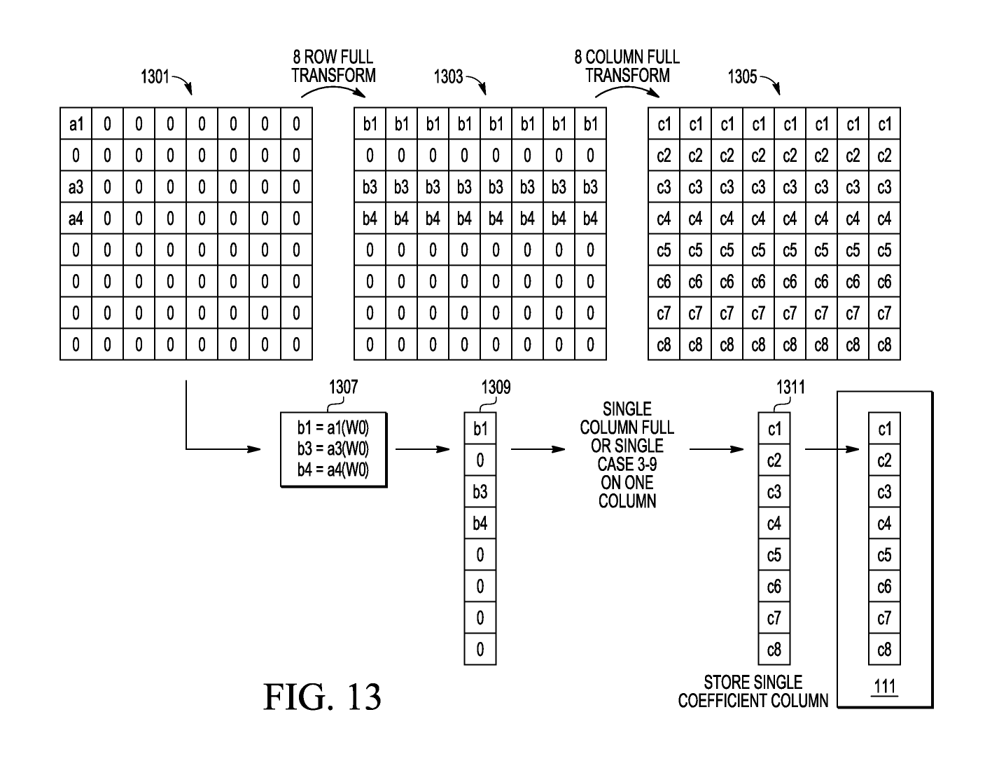

FIG. 13 is a block diagram illustrating reduced complexity inverse transform of a LEFT block 1301 having the form of the LEFT block 211. The LEFT block 1301 has one or more non-zero coefficients in the first left-most column and otherwise is filled with zero coefficients. As shown, the LEFT block 1301 includes a first column [a1, 0, a3, a4, 0, 0, 0, 0] with only three non-zero coefficients. An intermediate block 1303 is shown as the result of a full 1D butterfly IDCT for each row of the LEFT block 1301, in which each position in the top row of 1303 is a coefficient “b1”, each position in the third row from the top is a coefficient “b3”, each position in the fourth row is a coefficient “b4”, and the remaining coefficients are zeroes. A residual block 1305 is shown as the result of a full 1D butterfly IDCT for each column of the intermediate block 1303, in which the top row is filled with a coefficient “c1” in each position, the second row is filled with a coefficient “c2” in each position, the third row is filled with a coefficient “c3” in each position, the fourth row is filled with a coefficient “c4” in each position, the fifth row is filled with a coefficient “c5” in each position, the sixth row is filled with a coefficient “c6” in each position, the seventh row is filled with a coefficient “c7” in each position, and the last row is filled with a coefficient “c8” in each position. In a conventional configuration, a full 1D butterfly IDCT is performed for each row of the LEFT block 1301 resulting in the intermediate block 1303, followed by a full 1D butterfly IDCT performed for each column of the intermediate block 1303 resulting in the residual block 1305, which was then stored in memory in its entirety for the subsequent addition.

The reduced complexity inverse transform module 109, however, simplifies the entire process for transforming the LEFT block 1301 to provide the same results with significantly less computations. Each row of the LEFT block 1301 has the form of the first set 202 for case 2, so that each row having a first non-zero coefficient is transformed with a single computation. Rows that do not have any non-zero coefficients are ignored or otherwise not processed. In one embodiment as shown at 1307, the inverse transform module 109 receives the block information BI indicating a LEFT block, and the inverse transform module 109 performs a single computation for each row having a non-zero in the first position. Since only three rows have non-zero coefficients in the first position, only three computations are performed as shown at 1307: for the first row, b1=a1(W0), for the third row, b3=a3(W0), and for the fourth row, b4=a4(W0). It is noted that up to eight computations may be performed when the LEFT block has a non-zero coefficient in each position of the first column. The result is an intermediate column 1309 representing the entire intermediate block 1303, in which a zero is inserted for each position in the intermediate column 1309 that does not have a non-zero coefficient. The intermediate column 1309 does not have any of the forms of cases 2-9, so that a full 1D butterfly transform is performed to provide a residual column 1311 with coefficients [c1, c2, c3, c4, c5, c6, c7, c8]. It is noted that although a full 1D inverse transform is performed in the illustrated case, it is only for one column rather than for each column of the intermediate block 1303. The residual column 1311 is then stored into the memory 111 rather than the residual block 1305. In summary, for the LEFT block 1301, only one computation is performed for each row having a non-zero coefficient in the first position resulting in an intermediate column 1309 representing the intermediate block 1303, and only a single 1D full butterfly IDCT is performed for the intermediate column 1309 to provide a residual column 1311 representing the residual block 1305 thereby substantially reducing computations. Only the residual column 1311 is stored in the memory 111 rather than the entire residual block 1305 thereby substantially reducing memory store operations.

It is noted that the input transform block may be according to a special simplified case of the LEFT block 211, in which only one non-zero coefficient exists in the left column other than in the DC position (e.g., any position other than the top-left corner). For example, suppose that the left block 1301 includes only one non-zero coefficient in the left column other than the top DC position. In this case, only one computation is performed for the non-zero row, so that the intermediate column has only one non-zero coefficient in one position other than the top position. Then, the reduced complexity transform according to the corresponding one of cases 3-9 is selected based on the position of the non-zero coefficient in the intermediate column rather than the full transform to generate the final column of residual coefficients. As an example, if the coefficients “a1” and “a4” of the LEFT block 1301 are instead zeroes, then only one computation b3=a3(W0) is performed at 1307 to determine a single intermediate coefficient b3, and an intermediate column (not shown) is formed by inserting zeroes into positions other than the third position having the coefficient “b3”. In this example, the reduced complexity inverse transform according to case 4 is invoked for the intermediate column with the single non-zero coefficient “b3” in the third position to convert to a corresponding residual column (not shown) for storage into the memory 111.

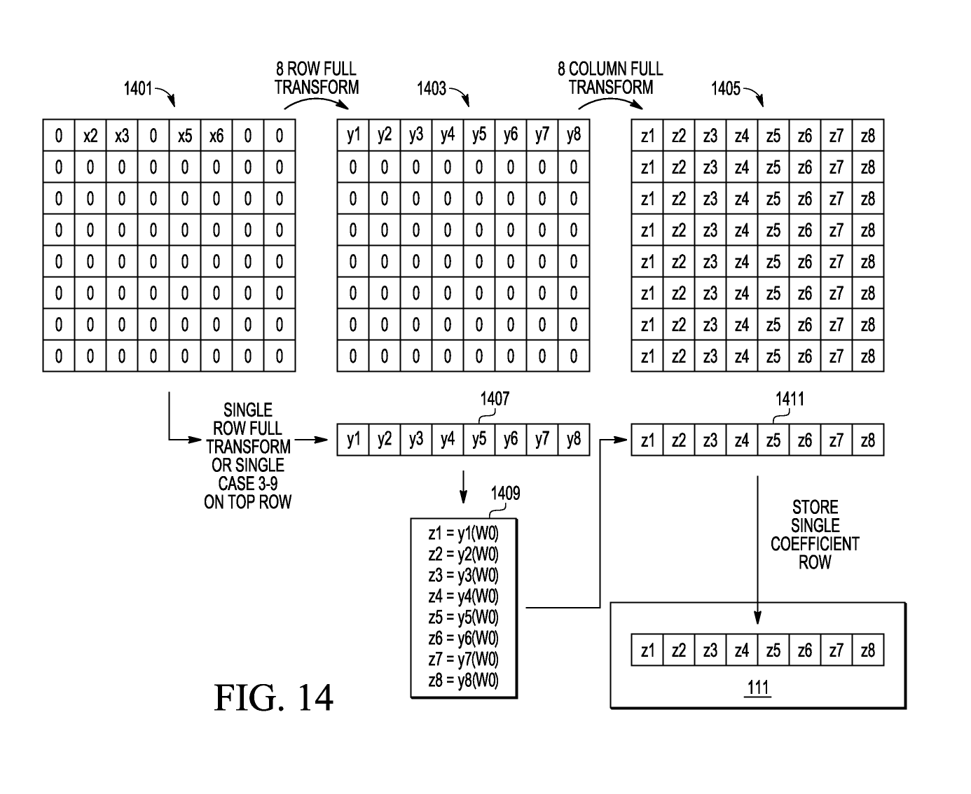

FIG. 14 is a block diagram illustrating reduced complexity inverse transform of a TOP block 1401 having the form of the TOP block 212. The TOP block 1401 has one or more non-zero coefficients in the top row and otherwise is filled with zero coefficients. As shown, the TOP block 1401 includes a top row of coefficients [0, x2, x3, 0, x5, x6, 0, 0] including four non-zero coefficients. An intermediate block 1403 is shown as the result of a full 1D butterfly IDCT for each row of the TOP block 1401, in which the top row includes a row of coefficients [y1, y2, y3, y4, y5, y6, y7, y8] and the remaining rows are filled with zeroes. A residual block 1405 is shown as the result of a full 1D butterfly IDCT for each column of the intermediate block 1403, in which each row duplicated as a row of coefficients [z1, z2, z3, z4, z5, z6, z7, z8]. Thus, the entire left column is filled with a coefficient z1, the next column is filled with a coefficient z2, and so on. In a conventional configuration, a full 1D butterfly IDCT is performed for each row of the TOP block 1401 resulting in the intermediate block 1403, followed by a full 1D butterfly IDCT performed for each column of the intermediate block 1403 resulting in the residual block 1405, which was then stored in memory in its entirety for the subsequent addition.

The reduced complexity inverse transform module 109, however, simplifies the entire process for transforming the TOP block 1401 to provide the same results with significantly less computations. Rather than performing a full inverse transform for each row of the TOP block 1401, a single 1D butterfly IDCT is performed for the top row resulting in an intermediate row 1407 with coefficients [y1, y2, y3, y4, y5, y6, y7, y8]. The intermediate row 1407 represents the entire intermediate block 1403. Each coefficient in the intermediate row 1407 is the first coefficient of a corresponding column of coefficients, in which only the first coefficient is non-zero. In this manner, each coefficient of the intermediate row 1407 represents an intermediate column having the form of the first set 202 for case 2. In this manner, only one computation is needed for each column having a non-zero top value as shown at 1409 for a total of up to 8 computations, shown as z1=y1(W0), z2=y2(W0), z3=y3(W0), z4=y4(W0), z5=y5(W0), z6=y6(W0), z7=y7(W0), and z8=y8(W0). It is noted that if any one or more of the y1-y8 coefficients is a zero, the corresponding computation is omitted and a zero coefficient is inserted for the corresponding “z” coefficient. These calculations shown at 1409 result in a residual row 1411 as a row of coefficients [z1, z2, z3, z4, z5, z6, z7, z8] representing the residual block 1405. The residual row 1411 is stored in the memory 111 rather than the residual block 1405. In summary, for the TOP block 1401, a full ID inverse transform is performed only for the top row resulting in an intermediate row 1409 representing the intermediate block 1403. Then, only one computation is performed for each non-zero coefficient in the intermediate row 1409 to provide a residual row 1411 representing the residual block 1405 thereby substantially reducing the number of computations. Only the residual row 1411 is stored in the memory 111 rather than the entire residual block 1405 thereby substantially reducing memory store operations.

It is noted that the input transform block may be according to a special simplified case of the TOP block 212, in which only one non-zero coefficient exists in the top row other than in the DC position (e.g., any position other than the top-left corner). In the simplified case, a corresponding reduced complexity inverse transform is selected based on the position of the non-zero coefficient in the row according to the corresponding one of the cases 3-9, and the selected reduced complexity inverse transform is performed rather than the full transform to achieve the intermediate row (e.g., intermediate row 1407). The remaining procedure is the same.

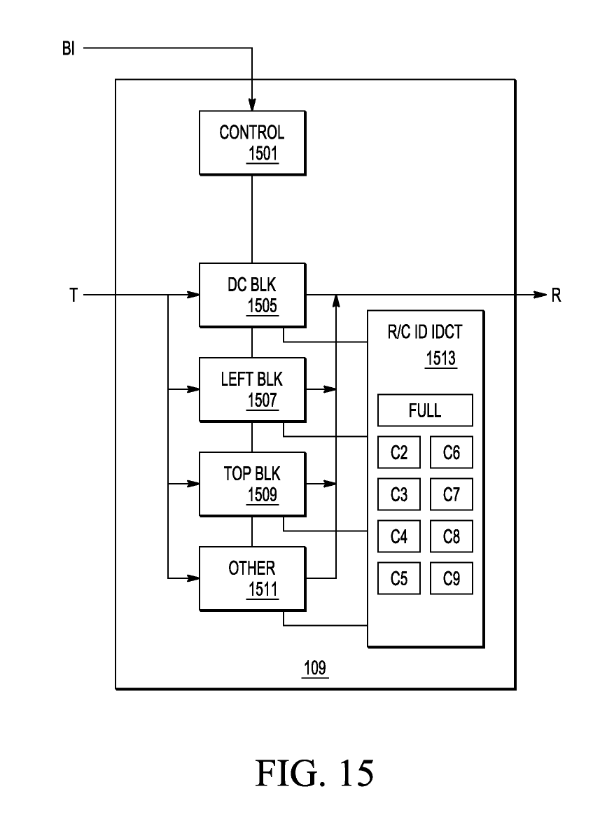

FIG. 15 is a more detailed block diagram of the inverse transform module 109 according to an exemplary embodiment. The inverse transform module 109 includes a control module 1501 receiving the block information BI, where the control module 1501 is further coupled to a DC BLK module 1505 for transforming any input transform block having the form of the DC block 210, a LEFT BLK module 1507 for transforming any input transform block having the form of the LEFT block 211, a TOP BLK module 1509 for transforming any input transform block having the form of the TOP block 212, and an OTHER module 1511 for transforming any input transform block not having the form of ZERO, DC, LEFT, or TOP. The OTHER module 1511 handles the case of full inverse transform for a block, but also includes cases in which at least a partial reduced complexity inverse transform is performed. For example, the cases handled by the other module 1511 include blocks having one or more rows or columns having a single non-zero coefficient such that the corresponding one of the cases 2-9 is applied. Each of the modules 1505, 1507, 1509 and 1511 receive the input transform blocks T, and a selected one provides the residual value R. The modules 1505, 1507, 1509 and 1511 are each coupled to a row/column (R/C) 1D IDCT module 1513, which includes separate modules for performing 1D inverse transform of any row or any column depending upon the particular array configuration. In particular, the R/C 1D IDCT module 1513 includes a module FULL for performing full 1D inverse transform of any row or column which is not according to any of the cases 2-9, a case 2 module (C2) for performing reduced complexity 1D inverse transform of any row or column according to case 2, a case 3 module (C3) for performing reduced complexity 1D inverse transform of any row or column according to case 3, a case 4 module (C4) for performing reduced complexity 1D inverse transform of any row or column according to case 4, a case 5 module (C5) for performing reduced complexity 1D inverse transform of any row or column according to case 5, a case 6 module (C6) for performing reduced complexity 1D inverse transform of any row or column according to case 6, a case 7 module (C7) for performing reduced complexity 1D inverse transform of any row or column according to case 7, a case 8 module (C8) for performing reduced complexity 1D inverse transform of any row or column according to case 8, and a case 9 module (C9) for performing reduced complexity 1D inverse transform of any row or column according to case 9.

The control module 1501 determines the form of each input transform block T from the inverse quantization module 107 and selects one of the modules 1505, 1507, 1509, and 1511 to convert the transform block T to the residual value R. If the transform block T is a ZERO block 201, then the control module 1501 does not select any of the modules 1505, 1507, 1509 and 1511 since computations and store operations are not performed for the block and inverse transform is bypassed or otherwise not performed. Otherwise, the control module 1501 invokes any of the modules 1505, 1507, 1509, and 1511 to convert the transform block T and to provide the corresponding residual value R. The modules 1505, 1507, 1509, and 1511 each invoke one or more of the FULL and C2-C9 modules of the R/C 1D IDCT module 1513 to complete the computations for conversion.

When the input transform block is the form of the DC block 210, the DC BLK module 1505 is invoked to determine a single coefficient (such as the “c” value shown at 1213) representing a corresponding residual block (e.g., block 1205), and the single coefficient is stored into the memory 111 to represent the residual block. In one embodiment, the DC BLK module 1505 invokes the C2 module with the input DC coefficient (e.g., coefficient “a” shown in block 1201), and the C2 module performs a single computation to provide a corresponding single intermediate coefficient (e.g., computation shown at 1207 using input coefficient “a” to provide intermediate coefficient “b”). The DC BLK module 1505 invokes the C2 module again with the intermediate coefficient, and the C2 module performs another single computation to provide a corresponding single residual coefficient to represent a residual block (e.g., computation shown at 1209 using input intermediate coefficient “b” to provide residual coefficient “c”). In an alternative embodiment, the DC BLK module 1505 performs a single computation to determine the output residual coefficient (e.g., computation shown at 1211 to convert input transform coefficient “a” directly to residual coefficient “c”). In either case, the DC BLK module 1505 then stores the single output residual coefficient into the memory 111.

When the input transform block is the form of the LEFT block 211, the LEFT BLK module 1507 is invoked to perform the computations for determining a single residual column (e.g., residual column 1311) representing a residual block (e.g., block 1305), and then the LEFT BLK module 1507 stores the output residual column into the memory 111. The LEFT BLK module 1507 invokes the C2 module for each row of the input transform block having a non-zero initial coefficient, in which the C2 module performs a single computation each time it is invoked (e.g., computations shown at 1307). The LEFT BLK module 1507 constructs the intermediate column (e.g., intermediate column 1309) by inserting a zero in each position for which a computation was not performed, and then the LEFT BLK module 1507 invokes either the FULL module or a selected one of the C3-C9 modules to convert the intermediate column into a residual column (e.g., residual column 1311). The LEFT BLK module 1507 stores the resulting residual column into memory 111.

It is noted that the input transform block may be according to a special case of the LEFT block 211, in which only one non-zero coefficient exists in the left column other than in the DC position (e.g., any position in the left column other than the top-left corner). In this case, the C2 module is invoked only once to convert the single row into a single intermediate coefficient, and the LEFT block 211 inserts zeroes into remaining positions to form an intermediate column. Then, a corresponding one of the C3-C9 modules is invoked to convert the single intermediate column into a residual column (having different coefficients than 1311). The particular one of the C3-C9 modules is selected based on the position of the non-zero coefficient.

When the input transform block is the form of the top block 212, the TOP BLK module 1509 is invoked to perform the computations for determining a single residual row (e.g., residual row 1411) representing a residual block (e.g., block 1405), and then the TOP BLK module 1509 stores the resulting residual row into the memory 111. The TOP BLK module 1509 invokes the FULL module or a selected one of the C3-C9 modules (for a single non-zero coefficient case) for the top row of the input transform block to provide an intermediate row (e.g., intermediate row 1407). The TOP BLK module 1509 then invokes the C2 module to convert each non-zero coefficient of the intermediate row into a corresponding coefficient of a residual row (e.g., C2 module performs each of the computations shown at 1409 to provide the residual column 1411). The TOP BLK module 1509 stores the resulting residual row into memory 111.

It is noted that the input transform block may be according to a special case of the TOP block 212, in which only one non-zero coefficient exists in the top row other than in the

DC position (e.g., any position in the top row other than the top-left corner). In this case, rather than invoking the FULL module for the top row, a corresponding one of the C3-C9 modules is invoked to convert the top column into the intermediate row (not shown). The particular one of the C3-C9 modules selected depends upon the position of the non-zero coefficient. Operation then proceeds as previously described. For example, suppose that “x2” is the only non-zero coefficient in the top row of the transform block 1401. Then the module C3 is selected according to case 3 for determining a corresponding intermediate column similar to 1407 (with different coefficients).

When the input transform block is not according to any of the ZERO, DC, LEFT or TOP formats, then the OTHER module 1511 is invoked to convert the input transform block into a residual block and the entire residual block is stored into the memory 111. Although the complexity may not be reduced as much as for the ZERO, DC, LEFT or TOP formats, whenever any row or any column is according to any of the cases 2-9, then the corresponding one of the C2-C9 modules from the R/C 1D IDCT module 1513 is invoked to convert the row or column. In this manner, reduced complexity is achieved even if the input transform block is not according to any of the ZERO, DC, LEFT or TOP formats.

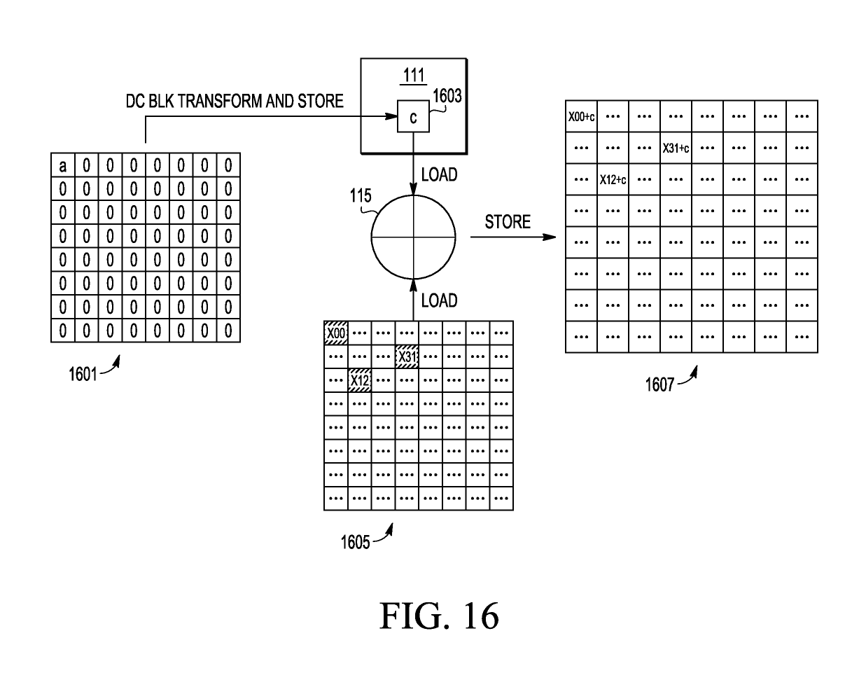

FIG. 16 is a figurative diagram illustrating reduced complexity inverse transform and reduced load and store operations for the DC block case according to an exemplary embodiment. A DC block 1601 provided to the inverse transform module 109 causes the inverse transform module 109 to determine and store a single residual coefficient “c” shown at 1603 into the memory 111. In one embodiment, each residual coefficient is a 16-bit value, so that rather than storing an entire 8×8 block of 16-bit coefficients into the memory 111, a single 16-bit coefficient is stored instead. The MC module 113 determines and provides an MC block 1605, which is loaded into one input of the adder 115. The single coefficient “c” is loaded into another input of the adder 115, which determines and stores an output video block 1607. Thus, rather than loading an entire block, load operations are reduced since only a single residual coefficient is loaded into the adder 115 as the residual value R. The adder 115 adds the single coefficient “c” to each value of the MC block 1605 to generate the corresponding values of the video block 1607.

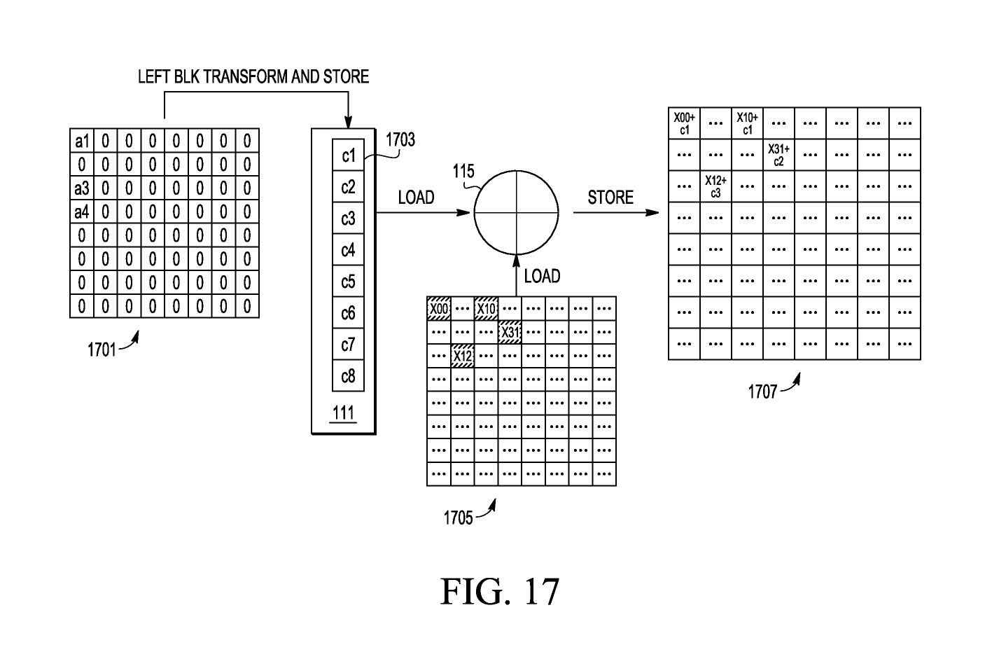

FIG. 17 is a figurative diagram illustrating reduced complexity inverse transform and reduced load and store operations for the LEFT block case according to an exemplary embodiment. A LEFT block 1701 provided to the inverse transform module 109 causes the inverse transform module 109 to determine and store a single residual column 1703 into the memory 111. The residual column 1703 is shown with coefficients [c1 , c2, c3, c4, c5, c6, c7, c8]. In one embodiment, each residual coefficient is a 16-bit value, so that rather than storing an entire 8×8 block of 16-bit coefficients into the memory 111, only an array of 8 16-bit coefficients is stored instead. The MC module 113 determines and provides an MC block 1705, which is loaded into one input of the adder 115. The residual column 1703 is loaded into the other input of the adder 115, which determines and stores an output video block 1707. Thus, rather than loading an entire block, load operations are reduced since only a residual column of coefficients is loaded into the adder 115 as the residual value R. The adder 115 adds the residual column 1703 to the MC block 1705 to generate the video block 1707. As shown, the first coefficient “c1” of the residual column 1703 is added to each value of the top row of the MC block 1705, the second coefficient “c2” of the residual column 1703 is added to each value of the second row of the MC block 1705, the third coefficient “c3” of the residual column 1703 is added to each value of the third row of the MC block 1705, and so on, to generate the corresponding values of the video block 1707.

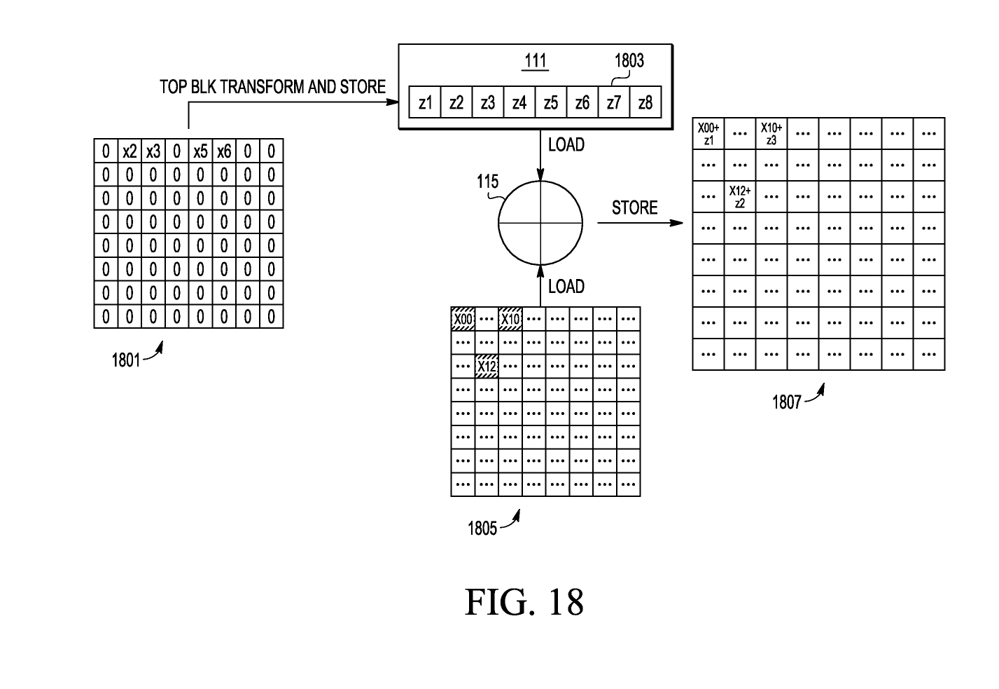

FIG. 18 is a figurative diagram illustrating reduced complexity inverse transform and reduced load and store operations for the TOP block case according to an exemplary embodiment. A TOP block 1801 provided to the inverse transform module 109 causes the inverse transform module 109 to determine and store a single residual row 1803 into the memory 111 as the residual value R. The residual row 1803 is shown with coefficients [z1, z2, z3, z4, z5, z6, z7, z8]. In one embodiment, each residual coefficient is a 16-bit coefficient, so that rather than storing an entire 8×8 block of 16-bit coefficients into the memory 111, only an array of 8 16-bit coefficients is stored instead. The MC module 113 determines and provides an MC block 1805, which is loaded into one input of the adder 115. The residual row 1803 is loaded into the other input of the adder 115, which determines and stores an output video block 1807. Thus, rather than loading an entire block, load operations are reduced since only a single residual row of coefficients is loaded into the adder 115 as the residual value R. The adder 115 adds the residual row 1803 to the MC block 1805 to generate the video block 1807. As shown, the first coefficient “z1” of the residual row 1803 is added to each value of the left column of the MC block 1805, the second coefficient “z2” of the residual row 1803 is added to each value of the second column from the left of the MC block 1805, the third coefficient “z3” of the residual row 1803 is added to each value of the third column from the left of the MC block 1805, and so on to generate the corresponding values of the video block 1807.

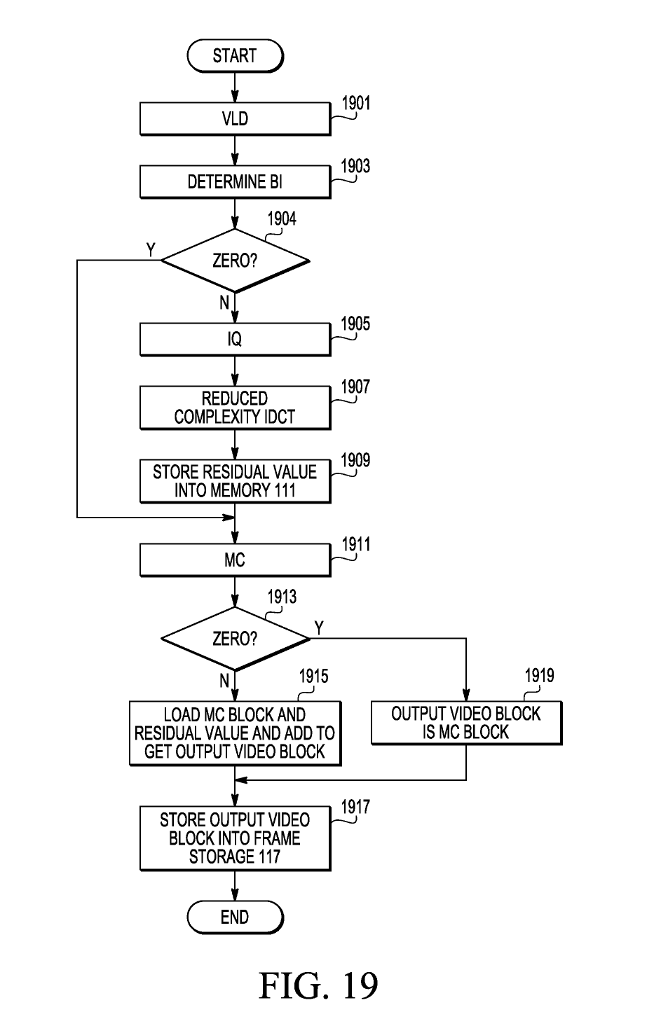

FIG. 19 is a flowchart diagram illustrating operation of the reduced complexity video decoder 101 according to an exemplary embodiment for each block processed. At first block 1901, the VLD process is performed by the VLD module 103 to convert variable length code from the BTS into VLD symbols S as previously described. At block 1903, the block information BI is determined for each data block as previously described. At block 1904, if the block information BI indicates a ZERO block, then operation advances directly to block 1911 for motion compensation further described below. Otherwise, if a ZERO block is not indicated at block 1904, then operation proceeds to block 1905 in which inverse quantization is performed by the inverse quantization module 107 to convert the VLD symbols S into corresponding a transform block T as previously described. At block 1907, reduced complexity IDCT is performed by the inverse transform module 109 to convert the transform block T into residual value R as previously described and as further described below. At block 1909, the residual value R is stored into the memory 111. In one embodiment, if a ZERO block was indicated at block 1904, blocks 1905, 1907 and 1909 are skipped.

At block 1911, motion compensation is performed by the MC module 113 to provide an MC block. At next block 1913, it is queried whether the block information BI indicates a ZERO block. If a ZERO block is not indicated by the block information BI as determined at block 1913, then operation advances to block 1915 in which the residual values R stored in the memory 111 and the MC block are loaded into the adder 115, and the values are added together to provide the output video block as previously described and as further described below. The video block output from the adder 115 is stored into the frame storage 117 at block 1917 as previously described and operation is completed for the video block. In one embodiment, if a ZERO block is indicated by the block information BI as determined at block 1913, then operation advances directly to block 1919 in which the stored MC block forms the output video block as represented by dashed line 119 as previously described. In this case, the MC block output from the MC module 113 is stored as the video block in the frame storage 117 at block 1917. In an alternative embodiment, block 1913 is not done and instead the adder 115 is configured to detect a ZERO block at block 1915, such that addition is bypassed and the MC block is passed through the adder 115 and stored as the output video block at block 1917. In either case, computations and store/load operations are eliminated for a ZERO block. Operation is repeated in similar manner for each input block being decoded.

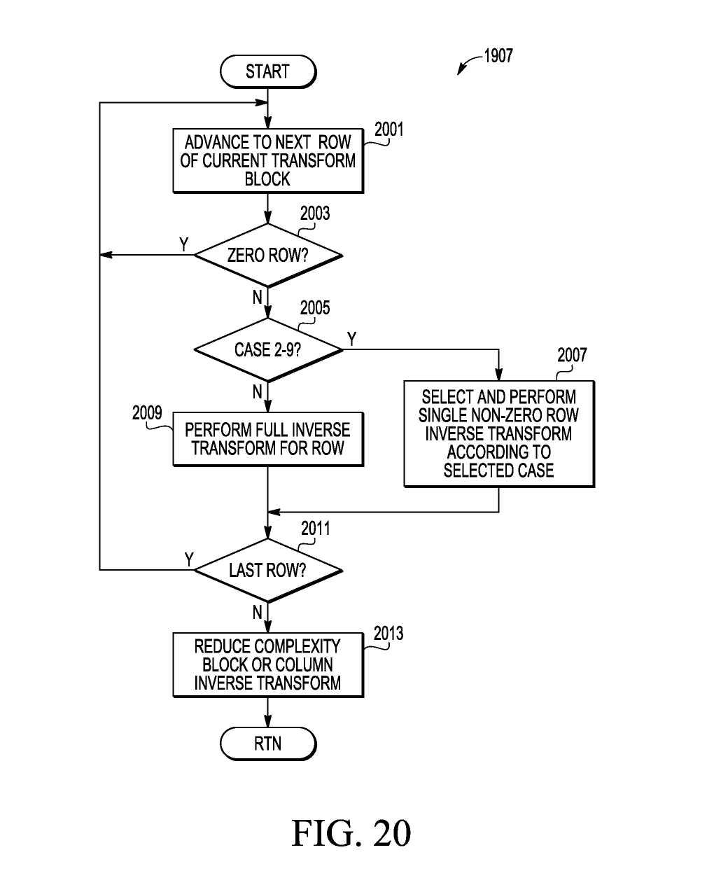

FIG. 20 is a flowchart diagram illustrating additional detail of reduced complexity IDCT at block 1907. At first block 2001, operation advances to the next row of the current transform block as the current row, which is the top row in the first iteration. At block 2003, it is queried whether the current row is a zero row meaning that it does not include any non-zero coefficients. If the row is a zero row, operation returns back to block 2001 to advance to the next row of the current transform block. It is noted that overall complexity is reduced since computations are bypassed for any row that does not have any non-zero coefficients. If at least one non-zero coefficient exists in the row, operation advances to block 2005 in which it is queried whether the row conforms to any of the cases 2-9 as previously described. If so, operation advances to block 2007 in which the corresponding case is determined and the corresponding single non-zero reduced complexity IDCT is performed. For example, a corresponding one of the C2-C9 modules is selected to perform reduced complexity inverse transform for the row. If the row is not according to any of the cases 2-9 as determined at block 2005, then operation advances instead to block 2009 in which the full inverse transform is performed for the row. After blocks 2007 or 2009, operation advances to block 2011 to query whether the current row is the last row. If not, operation returns to block 2001 to advance to the next row. Otherwise, operation advances to block 2013 to perform reduced complexity inverse transform for the transform block and/or for each column of the input block as further described below, and then operation returns to perform block 1909.

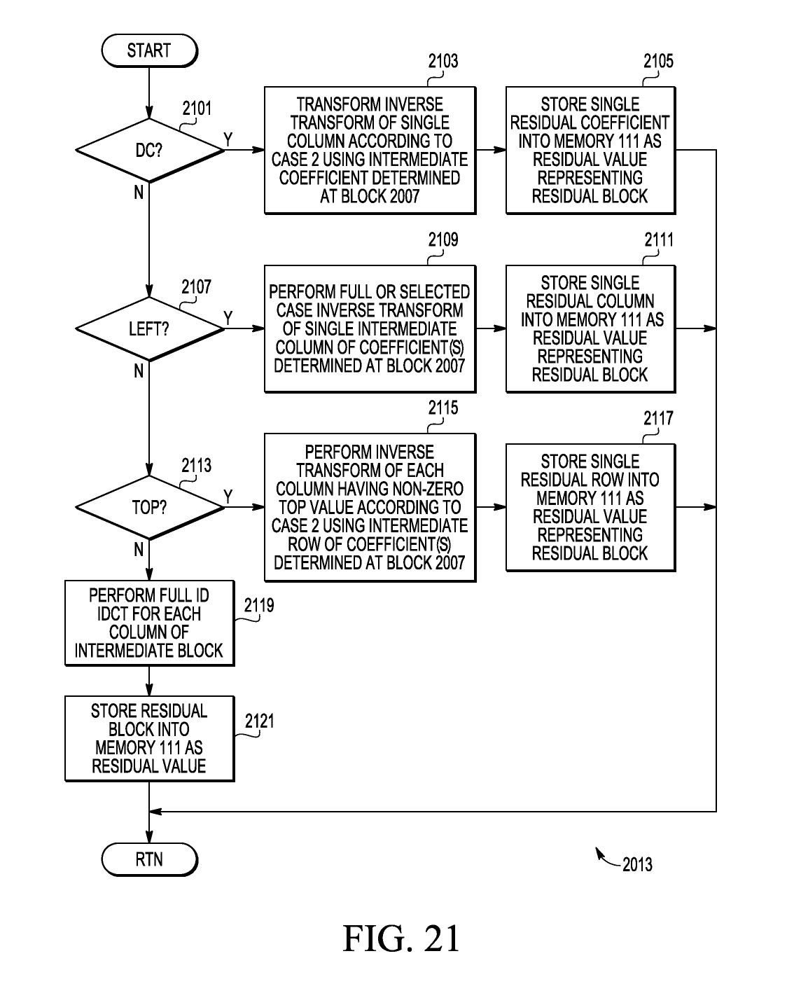

FIG. 21 is a flowchart diagram illustrating additional detail of block 2013 according to an exemplary embodiment. At first block 2101, it is queried whether the input transform block is a DC block. If a DC block, then at block 2103, an inverse transform of a single column according to case 2 is performed using the intermediate coefficient determined at block 2007 as the top value and filling in zeroes as previously described. Operation then advances to block 2105 to store a resulting single residual value into memory 111 as the residual value R. If not DC, then operation proceeds instead to block 2107 to query whether the input transform block is a LEFT block. If a LEFT block, operation advances to block 2109 to perform a full or selected case inverse transform of a single intermediate column of coefficients determined at block 2007 as previously described. If any of cases 3-9 apply, then the selected case inverse transform is performed, and otherwise a full column inverse transform is performed. Operation then advances to block 2111 to store the resulting residual column into the memory 111 as the residual value R. If not LEFT, then operation proceeds instead to block 2113 to query whether the input transform block is a TOP block. If a TOP block, operation advances to block 2115 to perform an inverse transform according to case 2 for each column having a non-zero top value using an intermediate row of coefficients determined at block 2007 as previously described. Operation then advances to block 2117 to store a resulting single residual row into the memory 111 as the residual value R. If not DC, LEFT or TOP, then operation proceeds instead to block 2119 in which the full 1D IDCT transform is performed for each column of the intermediate block, and then to block 2121 to store a resulting residual block into the memory 111 as the residual value R. After any of blocks 2105, 2111, 2117 or 2121, operations returns to perform block 1909 as previously described.

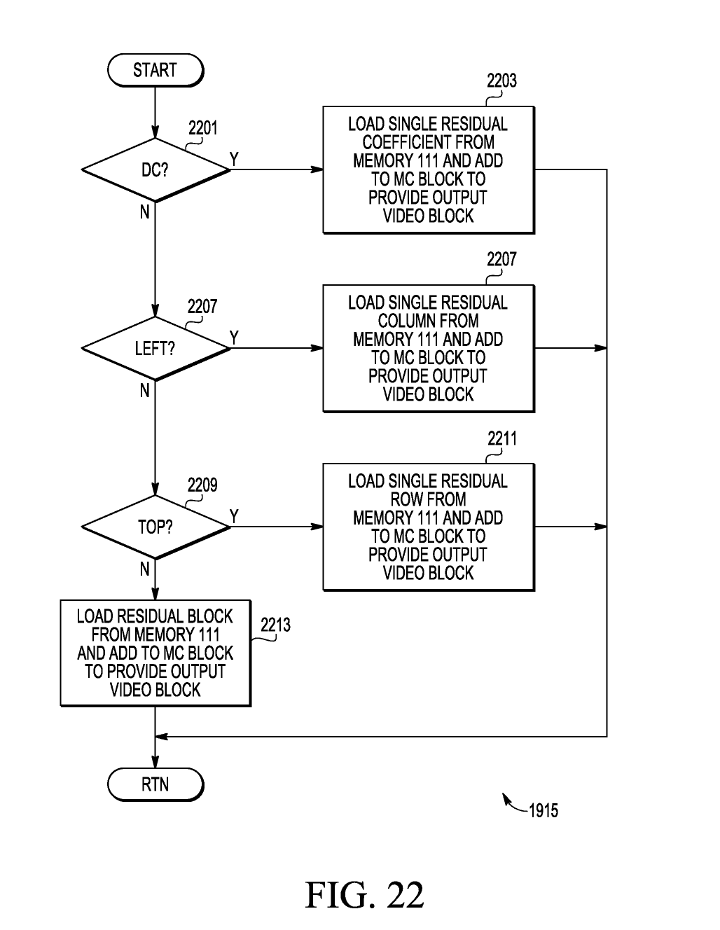

FIG. 22 is a flowchart diagram illustrating additional detail of block 1915 according to an exemplary embodiment. At first block 2201, if the input transform block is DC, operation proceeds to block 2203 in which a residual value stored in the memory 111 is loaded into the adder 115 along with the MC block and the two are added together as previously described. In this manner, only a single value is loaded into the adder 115 from the memory 111 substantially reducing memory load, and the single value is added to each value of the MC block. If instead the input block is a LEFT block as determined at block 2205, operation proceeds to block 2207 in which a single residual column stored in the memory 111 is loaded into the adder 115 along with the MC block and the two are added together as previously described. In this manner, only one column of values from the memory 111 is loaded into the adder 115 from the memory 111 substantially reducing memory load, and one value from the residual column is added to each value of a corresponding row of the MC block. If instead the input block is a TOP block as determined at block 2209, operation proceeds to block 2211 in which a residual row of values stored in the memory 111 is loaded into the adder 115 along with the MC block and the two are added together as previously described. In this manner, only one row from the memory 111 is loaded into the adder 115 substantially reducing memory load, and one value from each of the residual row is added to each value of a corresponding column of the MC block. If the input block is not ZERO, DC, LEFT or TOP, then operation proceeds to block 2213 in which a residual block of values stored in the memory 111 is loaded into the adder 115 along with the MC block and the two are added together as previously described. After any of blocks 2203, 2207, 2211 or 2213, operation returns to perform block 1917.

A method of reducing processing of fast inverse transform of an input transform block by a video decoder according to one embodiment includes determining whether a block type of the input transform block is one of zero, DC, left, and top, when the block type is not one of zero, DC, left, and top, performing inverse transform of the input transform block and providing a residual video block, when the block type is zero, bypassing inverse transform of the input transform block, when the block type is DC, performing reduced complexity inverse transform of a DC coefficient of the input transform block and providing only a single residual coefficient representing the residual video block, when the block type is left, performing reduced complexity inverse transform of a left column of the input transform block and providing only a single column of residual coefficients representing the residual video block, and when the block type is top, performing reduced complexity inverse transform of a top row of the input transform block and providing only a single row of residual coefficients representing the residual video block.

When the block type is DC, the method may include performing a corresponding one of multiple reduced complexity single coefficient inverse transforms of a first row of the input transform block to provide a single intermediate coefficient representing an intermediate transform block, and performing the corresponding reduced complexity single coefficient inverse transform using the single intermediate coefficient to provide a single residual coefficient representing the residual video block.

When the block type is left, then each row of the input transform block is processed. The method may include bypassing inverse transform of the row and providing a zero into a corresponding position of a single column of intermediate transform coefficients representing an intermediate transfer block when the row includes only zero coefficients. The method may further include performing a corresponding one of the reduced complexity single coefficient inverse transforms of the row to provide a corresponding single intermediate coefficient at a corresponding position of the single column of intermediate transform coefficients when the row has a non-zero coefficient. The method further may include performing inverse transform of the single column of intermediate transform coefficients to provide a single column of residual coefficients representing the residual video block.

When the block type is top, the method may include performing inverse transform of the top row of the input transform block to provide a single row of intermediate transform coefficients, and performing a corresponding one of the reduced complexity single coefficient inverse transforms of each coefficient of the single row of intermediate transform coefficients to provide a single row of residual coefficients representing the residual video block.

When the block type is not one of zero, DC, left, and top, then each row of the input transform block is processed during the 1D row-transform stage and the 1D column-transform stage. For each row, when the row includes only zero coefficients, the method may include bypassing inverse transform of the row and providing zeroes into a corresponding row of an intermediate transform block. When the row includes only one non-zero coefficient, the method may include performing a corresponding one of multiple reduced complexity single coefficient inverse transforms of the row to provide a corresponding row of the intermediate transform block. When the row includes more than one non-zero coefficient, the method may include performing full inverse transform of the row to provide a corresponding row of the intermediate transform block. Then the method may include performing inverse transform of each column of the intermediate transform block to provide the residual video block.

An inverse transform system which performs reduced complexity inverse transform of an input transform block according to one embodiment includes an “other” module, a DC module, a left module, a top module and a control module. The “other” module performs inverse transform of the input transform block and provides a residual block when a block type of the input transform block is not one of zero, DC, left and top. The DC module performs reduced complexity inverse transform of a DC coefficient of the input transform block and provides only a single residual coefficient representing the residual block when the block type is DC. The left module performs reduced complexity inverse transform of a left column of the input transform block and provides only a single column of residual coefficients representing the residual block when the block type is left. The top module performs reduced complexity inverse transform of a top row of the input transform block and provides only a single row of residual coefficients representing the residual block when the block type is top. The control module invokes one of the other, DC, left and top modules based on the block type when the block type is not zero, and which otherwise bypasses inverse transform of the input transform block.

A video decoder according to one embodiment includes a variable length decoding module, block information module, an inverse quantization module, an inverse transform module, a motion compensation module, and an adder. The variable length decoding module receives input video information and provides decoding symbols. The block information module determines a block type based on decoding information. The inverse quantization module receives the decoding symbols and provides a transform block. The inverse transform module bypasses inverse transform when the block type is zero and otherwise performs inverse transform of the transform block to provide residual information. The inverse transform module provides a residual video block as the residual information when the block type is not one of zero, DC, left and top. The inverse transform module performs reduced complexity inverse transform of a DC coefficient of the transform block and provides only a single residual coefficient as the residual information when the block type is DC. The inverse transform module performs reduced complexity inverse transform of a left column of the transform block and provides only a single column of residual coefficients as the residual information when the block type is left. The inverse transform module performs reduced complexity inverse transform of a top row of the transform block and provides only a single row of residual coefficients as the residual information when the block type is top. The motion compensation module provides a motion compensation block, and the adder adds the residual information to the motion compensation block to provide an output video block.

Although the present invention has been described in considerable detail with reference to certain preferred versions thereof, other versions and variations are possible and contemplated. For example, circuits or modules described herein may be implemented as an combination of discrete circuitry, logic, integrated circuitry, software, firmware, etc., or any combination thereof. The term “video information” as used herein is intended to apply to any video or image sequence information. Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

1. A method of reducing processing of fast inverse transform of an input transform block by a video decoder, comprising:
determining whether a block type of the input transform block is one of zero, direct current, left, and top;
when the block type is not one of zero, direct current, left, and top, performing inverse transform of the input transform block and providing a residual video block;
when the block type is zero, bypassing inverse transform of the input transform block;
when the block type is direct current, performing reduced complexity inverse transform of a direct current coefficient of the input transform block and providing only a single residual coefficient representing the residual video block;
when the block type is left, performing reduced complexity inverse transform of a left column of the input transform block and providing only a single column of residual coefficients representing the residual video block; and
when the block type is top, performing reduced complexity inverse transform of a top row of the input transform block and providing only a single row of residual coefficients representing the residual video block.

2. The method of claim 1, wherein when the block type is not one of zero, direct current, left, and top, said performing inverse transform of the input transform block comprises:
for each row of the input transform block:
when the row comprises only zero coefficients, bypassing inverse transform of the row and providing zeroes into a corresponding row of an
when the row comprises only one non-zero coefficient, performing a corresponding one of a plurality of reduced complexity single coefficient inverse transforms of the row to provide a corresponding row of the intermediate transform block; and
when the row comprises more than one non-zero coefficient, performing full inverse transform of the row to provide a corresponding row of the intermediate transform block; and
performing inverse transform of each column of the intermediate transform block to provide the residual video block.

3. The method of claim 2, wherein for each row of the input transform block comprising only one non-zero coefficient when the block type is not one of zero, direct current, left, and top, further comprising selecting a reduced complexity single coefficient inverse transform based on a position of the non-zero coefficient within the row.

4. The method of claim 2, wherein said performing inverse transform of each column of the intermediate transform block comprises, for each column, performing a corresponding one of a plurality of reduced complexity single coefficient inverse transforms of the column to provide a corresponding column of the intermediate transform block when the column comprises only one non-zero coefficient, bypassing inverse transform if the column comprises only zero coefficients, and otherwise performing full inverse transform of the column.

5. The method of claim 1, wherein when the block type is direct current, said performing reduced complexity inverse transform of the direct current coefficient comprises:
performing a corresponding one of a plurality of reduced complexity single coefficient inverse transforms of a first row of the input transform block to provide a single intermediate coefficient representing an intermediate transform block; and
performing the corresponding reduced complexity single coefficient inverse transform using the single intermediate coefficient to provide a single residual coefficient representing the residual video block.

6. The method of claim 1, wherein when the block type is left, said performing reduced complexity inverse transform of the left column of the input transform block comprises:
for each row of the input transform block, when the row comprises only zero coefficients, bypassing inverse transform of the row and providing a zero into a corresponding position of a single column of intermediate transform coefficients representing an intermediate transfer block;
for each row of the input transform block, when the row comprises a non-zero coefficient, performing a corresponding one of the plurality of reduced complexity single coefficient inverse transforms of the row to provide a corresponding single intermediate coefficient at a corresponding position of the single column of intermediate transform coefficients; and
performing inverse transform of the single column of intermediate transform coefficients to provide a single column of residual coefficients representing the residual video block.

7. The method of claim 6, wherein said performing inverse transform of the single column of intermediate transform coefficients comprises performing full inverse transform of the single column of intermediate transform coefficients when the single column of intermediate transform coefficients comprises more than one non-zero coefficient, and otherwise performing a corresponding one of the plurality of reduced complexity single coefficient inverse transforms of the single column of intermediate transform coefficients.

8. The method of claim 1, wherein when the block type is top, said performing reduced complexity inverse transform comprises:
performing inverse transform of the top row of the input transform block to provide a single row of intermediate transform coefficients; and
performing a corresponding one of the plurality reduced complexity single coefficient inverse transforms of each coefficient of the single row of intermediate transform coefficients to provide a single row of residual coefficients representing the residual video block.

9. The method of claim 8, wherein said performing inverse transform of the top row of intermediate transform coefficients comprises performing full inverse transform when the first row of intermediate transform coefficients comprises more than one non-zero coefficient, and otherwise performing a corresponding one of the plurality of reduced complexity single coefficient inverse transforms of the first row of intermediate transform coefficients.

10. The method of claim 1, further comprising:
performing motion compensation to provide a motion compensation block;
when the block type is direct current, adding the single residual coefficient to each coefficient within the motion compensation block;
when the block type is left, adding each coefficient of the single column of residual coefficients to each coefficient within a corresponding row of the motion compensation block; and
when the block type is top, adding each coefficient of the single row of residual coefficients to each coefficient within a corresponding column of the motion compensation block.

11. An inverse transform system which performs reduced complexity inverse transform of an input transform block, comprising:
an other module which performs inverse transform of the input transform block and which provides a residual block when a block type of the input transform block is not one of zero, direct current, left and top;
a direct current module which performs reduced complexity inverse transform of a direct current coefficient of the input transform block and which provides only a single residual coefficient representing said residual block when said block type is direct current;
a left module which performs reduced complexity inverse transform of a left column of the input transform block and which provides only a single column of residual coefficients representing said residual block when said block type is left;
a top module which performs reduced complexity inverse transform of a top row of the input transform block and which provides only a single row of residual coefficients representing said residual block when said block type is top; and
a control module which invokes one of said full, direct current, left and top modules based on said block type when said block type is not zero, and which otherwise bypasses inverse transform of the input transform block.

12. The inverse transform system of claim 11, further comprising:
an inverse transform array module which performs inverse transform of an array of coefficients representing one of a row and a column of a block of coefficients, wherein said inverse transform array module performs full inverse transform of said array when said array comprises more than one non-zero coefficient, and wherein said inverse transform array module performs one of a plurality of reduced complexity single coefficient transforms of said array when said array comprises only one non-zero coefficient.

13. The inverse transform system of claim of claim 12, wherein said inverse transform array module selects one of said plurality of reduced complexity single coefficient transforms based on a relative position of said non-zero coefficient within said array.

14. The inverse transform system of claim of claim 11, wherein said direct current module performs a corresponding one of a plurality of reduced complexity single coefficient inverse transforms of a first row of the input transform block to provide a single intermediate coefficient representing an intermediate transform block, and performs said corresponding reduced complexity single coefficient inverse transform using said single intermediate coefficient to provide a single residual coefficient representing said residual block.

15. The inverse transform system of claim 11, wherein said left module bypasses inverse transform of each row of the input transform block comprising only zero values and provides a zero into a corresponding position of a single column of intermediate transform coefficients representing an intermediate transfer block, performs a corresponding one of a plurality of reduced complexity single coefficient inverse transforms of each row comprising a single non-zero coefficient to provide a corresponding single intermediate coefficient at a corresponding position of said single column of intermediate transform coefficients, and performs inverse transform of said single column of intermediate transform coefficients to provide a single column of residual coefficients representing said residual block.

16. The inverse transform system of claim of claim 11, wherein said top module performs inverse transform of a top row of the input transform block to provide a single row of intermediate transform coefficients, and performs a corresponding one of a plurality reduced complexity single coefficient inverse transforms of each coefficient of said single row of intermediate transform coefficients to provide a single row of residual coefficients representing said residual block.

17. A video decoder, comprising:
a variable length decoding module which receives input video information and which provides decoding symbols;
a block information module which determines a block type based on decoding information, wherein said block type comprises one of zero, direct current, left, and top;
an inverse quantization module which receives said decoding symbols and which provides a transform block;
an inverse transform module which bypasses inverse transform when said block type is zero and which otherwise performs inverse transform of said transform block to provide residual information, wherein:
said inverse transform module provides a residual video block as said residual information when said block type is not one of zero, direct current, left and top;
wherein said inverse transform module performs reduced complexity inverse transform of a direct current coefficient of said transform block and provides only a single residual coefficient as said residual information when said block type is direct current;
wherein said inverse transform module performs reduced complexity inverse transform of a left column of said transform block and provides only a single column of residual coefficients as said residual information when said block type is left; and
wherein said inverse transform module performs reduced complexity inverse transform of a top row of said transform block and provides only a single row of residual coefficients as said residual information when said block type is top;
a motion compensation module which provides a motion compensation block; and
an adder which adds said residual information to said motion compensation block to provide an output video block.

18. The video decoder of claim 17, wherein said inverse transform module performs a corresponding one of a plurality of reduced complexity single coefficient inverse transforms of a first row of said transform block to provide a single intermediate coefficient, and performs said corresponding reduced complexity single coefficient inverse transform using said single intermediate coefficient to provide a single residual coefficient representing said residual video block.

19. The video decoder of claim 17, wherein said inverse transform module bypasses inverse transform of each row of said transform block comprising only zero values, performs a corresponding one of a plurality of reduced complexity single coefficient inverse transforms of each row comprising a single non-zero coefficient to provide a corresponding single intermediate coefficient at a corresponding position of a single column of intermediate transform coefficients, and performs inverse transform of said single column of intermediate transform coefficients to provide a single column of residual coefficients representing said residual video block.

20. The video decoder of claim 17, wherein said inverse transform module performs inverse transform of a top row of said transform block to provide a single row of intermediate transform coefficients, and performs a corresponding one of a plurality reduced complexity single coefficient inverse transforms of each non-zero coefficient of said single row of intermediate transform coefficients to provide a single row of residual coefficients representing said residual video block.
